(19) United States
(12) Patent Application Publication
(10) Pub. No.: US 2018/0024645 A1
(43) Pub. Date: Jan. 25, 2018

(54) METHOD AND SYSTEM FOR ASSEMBLING BACKLIGHT MODULE

(71) Applicant: PRIMAX ELECTRONICS LTD., Taipei (TW)

(72) Inventors: Chung-Yuan Chen, Taipei (TW); Bing Zhang, Taipei (TW)

(21) Appl. No.: 15/723,438

(22) Filed: Oct. 3, 2017

Related U.S. Application Data
(62) Division of application No. 15/220,873, filed on Jul. 27, 2016.

(30) Foreign Application Priority Data
Apr. 18, 2016 (CN) 201610239929.9

(51) Int. Cl. G06F 3/02

(52) U.S. Cl. CPC G06F 3/0202

(57) ABSTRACT

A backlight module assembling method is provided for assembling a backlight module of a luminous keyboard. The backlight module includes a first coupled element and a second coupled element in a stack form. Firstly, a positioning device is provided. After the first coupled element is aligned with a predetermined position of an assembling table surface through the positioning device, the first coupled element is placed on the predetermined position. Then, the first coupled element on the predetermined position is adsorbed according to vacuum adsorption. Consequently, the first coupled element is evenly fixed on the predetermined position. After the first coupled element is evenly fixed on the predetermined position, the second coupled element is aligned with and placed on the first coupled element. Consequently, the second coupled element and the first coupled element are combined together.

### CROSS-REFERENCE TO RELATED APPLICATION

This is a divisional application of U.S. patent application Ser. No. 15/220,873, filed Jul. 27, 2016, and entitled, “METHOD AND SYSTEM FOR ASSEMBLING BACKLIGHT MODULE,” which is herein incorporated by reference.

### FIELD OF THE INVENTION

The present invention relates to an assembling method, and more particularly to a backlight module assembling method and an assembling system using the method.

### BACKGROUND OF THE INVENTION

Recently, with increasing development of information industries, portable information devices such as notebook computers, mobile phones or personal digital assistants are widely used in many instances. In case that a portable information device is used in a dim environment, the numbers and the characters marked on the keys of the keyboard of the portable information device are not clearly visible. In other words, the dim environment becomes hindrance from operating the keyboard. In addition, if the numbers and the characters marked on the keys of the keyboard are reluctantly viewed in the dim environment, the user is readily suffered from vision impairment. For solving these drawbacks, a luminous keyboard has been disclosed. The luminous keyboard can be used in the dim environment in order to enhance the applications thereof. Moreover, by changing the layout of the luminous regions of the luminous keyboard, the information device having the luminous keyboard is more aesthetically-pleasing and thus the competiveness thereof is enhanced.

Please refer to FIGS. 1 and 2. FIG. 1 is a schematic cross-sectional view illustrating a portion of the conventional luminous keyboard. FIG. 2 is a schematic exploded view illustrating a backlight module of the conventional luminous keyboard of FIG. 1. The luminous keyboard 1 comprises a keyboard module 11 and a backlight module 12. The backlight module 12 is disposed under the keyboard module 11 for providing light beams to the keyboard module 11. The keyboard module 11 comprises plural keys. From top to bottom, the backlight module 12 comprises a light-shading plate 121, a light guide plate 122, a reflective plate 123, and a flexible circuit board 124 with a light source.

The light source comprises plural light emitting diodes 125. The reflective plate 123 has plural reflective plate openings 1231 corresponding to the plural light emitting diodes 125. The light guide plate 122 has plural light guide plate openings 1221 and plural light guide blocks 1222. The plural light guide plate openings 1221 are aligned with the corresponding light emitting diodes 125. For succinctness, only two light guide blocks 1222 are shown in FIG. 2. It is noted that the number of the light guide blocks 1222 is not restricted. The light guide blocks 1222 are used for scattering the light beams upwardly. Generally, the plural light guide blocks 1222 are aligned with the corresponding keys 111 of the keyboard module 11. Each light guide block 1222 is composed of several light guide dots 1223. The light-shading plate 121 comprises plural light-transmissible regions 1211 and a light-shading region 1212. For succinctness, only two light-transmissible regions 1211 are shown in FIG. 2. It is noted that the number of the light-transmissible regions 1211 is not restricted. The plural light-transmissible regions 1211 are aligned with the corresponding light guide blocks 1222. The light-shading region 1212 is arranged around the plural light-transmissible regions 1211.

Moreover, after each light emitting diode 125 is penetrated from a bottom side of the reflective plate 123 and upwardly through the corresponding reflective plate opening 1231 and the corresponding light guide plate opening 1221 sequentially, the light emitting diode 125 is embedded within the backlight module 12. When electricity is provided to the flexible circuit board 124, the light source emits the light beams. After the light beams are introduced into the light guide plate 122, the light beams are diffused to the entire of the light guide plate 122. Due to the material properties of the light guide dots 1223, the light beams are scattered upwardly or downwardly by the light guide dots 1223. The portions of the light beams that are scattered upwardly will be transmitted through the corresponding light-transmissible regions 1211 of the light-shading plate 121 and projected to the corresponding keys 111 of the keyboard module 11. The portions of the light beams that are scattered downwardly will be reflected back to the light guide plate 122 by the reflective plate 123. Consequently, the light beams provided by the light source can be well utilized to illuminate the plural keys 111.

A method of assembling the conventional backlight module 12 will be illustrated as follows. FIG. 3 is a schematic exploded view illustrating the stock materials of the conventional backlight module. In the production line of the backlight module 12, plural light-shading plate stock materials 21, plural light guide plate stock materials 22, plural reflective plate stock materials 23 and plural flexible circuit board stock materials 24 are prepared. Each light-shading plate stock material 21 comprises a light-shading plate 121, a protective film 211 and plural colloidal glues 212. The protective film 211 is attached on a bottom surface of the light-shading plate 121. The plural colloidal glues 212 are arranged between the bottom surface of the light-shading plate 121 and the protective film 211. For succinctness, only two colloidal glues 212 are shown in FIG. 3. It is noted that the number of the colloidal glues 212 is not restricted. Each light guide plate stock material 22 comprises a light guide plate 122, an upper protective film 221 and a lower protective film 222. The upper protective film 221 is attached on a top surface of the light guide plate 122. The lower protective film 222 is attached on a bottom surface of the light guide plate 122. Each reflective plate stock material 23 comprises a reflective plate 123, an upper protective film 231, a lower protective film 232, plural upper colloidal glues 233 and plural lower colloidal glues 234. The upper protective film 231 is attached on a top surface of the reflective plate 123. The lower protective film 232 is attached on a bottom surface of the reflective plate 123. The plural upper colloidal glues 233 are arranged between the top surface of the reflective plate 123 and the upper protective film 231. For succinctness, only two upper colloidal glues 233 are shown in FIG. 3. It is noted that the number of the upper colloidal glues 233 is not restricted. The plural lower colloidal glues 234 are arranged between the bottom surface of the reflective plate 123 and the lower protective film 232. For succinctness, only two lower colloidal glues 234 are shown in FIG. 3. It is noted that the number of the lower colloidal glues 234 is not restricted.

For assembling the backlight module 12, the lower protective film 232 of the reflective plate stock material 23 is firstly removed by the assembling worker and then the reflective plate 123 is placed on the flexible circuit board 124 by the assembling worker. Through the plural lower colloidal glues 234 on the bottom surface of the reflective plate 123, the flexible circuit board 124 and the reflective plate 123 are glued together. Then, the upper protective film 231 of the reflective plate stock material 23 and the lower protective film 222 of the light guide plate stock material 22 are sequentially removed by the assembling worker, and the light guide plate 122 is placed on the top surface of the reflective plate 123 by the assembling worker. Through the upper colloidal glues 233 on the top surface of the reflective plate 123, the light guide plate 122 and the reflective plate 123 are glued together. Then, the upper protective film 221 of the light guide plate stock material 22 and the protective film 211 of the light-shading plate stock material 21 are sequentially removed by the assembling worker, and the light-shading plate 121 is placed on the top surface of the light guide plate 122 by the assembling worker. Through the colloidal glues 212 on the bottom surface of the light-shading plate 121, the light-shading plate 121 and the light guide plate 122 are glued together.

However, the assembling method of the conventional backlight module 12 still has some drawbacks. Firstly, since the entire of the assembling process is manually done, the assembling process is time-consuming and labor-intensive and is not suitable for mass production. Secondly, the assemble worker cannot assure that any coupled element is precisely aligned with the adjacent coupled element at the top side or the bottom side before these two coupled elements are glued together. For example, the assemble worker cannot assure that all reflective plate openings 1231 of the reflective plate 123 are aligned with the corresponding light emitting diodes 125 on the flexible circuit board 124 before the reflective plate 123 and the flexible circuit board 124 are glued together. If the reflective plate 123 and the flexible circuit board 124 are not precisely aligned with each other before they are glued together, the optical performance of the backlight module 12 is largely deteriorated. Thirdly, the light-shading plate 121, the reflective plate 123 and the flexible circuit board 124 are made of soft materials except for the light guide plate 122. Consequently, when two adjacent coupled elements at the top side and the bottom side are aligned with each other and glued together, one of the two coupled elements is possibly uneven, wrinkled or upturned. Under this circumstance, the assembling process becomes difficult, or even the assembled product is defective.

Therefore, the assembling method of the backlight module needs to be further improved.

### SUMMARY OF THE INVENTION

An object of the present invention provides an assembling method for assembling a backlight module in an automatic or semi-automatic manner in order to achieve the time-saving and labor-saving purposes. By the assembling method of the present invention, the assembling quality of the backlight module is increased, and the optical performance of the assembled backlight module is stabilized and enhanced.

Another object of the present invention provides a backlight module assembling system using the assembling method of the present invention.

In accordance with an aspect of the present invention, there is provided a backlight module assembling method for assembling a backlight module of a luminous keyboard. The backlight module includes a first coupled element and a second coupled element in a stack form. At least one of the first coupled element and the second coupled element is equipped with plural coupling objects. The first coupled element and the second coupled element being combined together through the plural coupling objects. Firstly, a positioning device is provided. After the first coupled element is aligned with a predetermined position of an assembling table surface through the positioning device, the first coupled element is placed on the predetermined position of the assembling table surface. Then, the first coupled element on the predetermined position is adsorbed according to vacuum adsorption. Consequently, the first coupled element is evenly fixed on the predetermined position of the assembling table surface. After the first coupled element is evenly fixed on the predetermined position of the assembling table surface, the second coupled element is aligned with and placed on the first coupled element. Consequently, the second coupled element and the first coupled element are combined together.

In accordance with another aspect of the present invention, there is provided a backlight module assembling system for assembling a backlight module of a luminous keyboard. The backlight module includes a first coupled element and a second coupled element in a stack form. At least one of the first coupled element and the second coupled element is equipped with plural coupling objects. The first coupled element and the second coupled element are combined together through the plural coupling objects. The backlight module assembling system includes a first vacuum adsorption platform, a first positioning device and a second vacuum adsorption platform. The first vacuum adsorption platform has a first assembling table surface. While the first coupled element is placed on the first assembling table surface, the first coupled element is aligned with a first predetermined position of the first assembling table surface through the first positioning device. The first coupled element on the first predetermined position of the first assembling table surface is adsorbed by the first vacuum adsorption platform according to vacuum adsorption, so that the first coupled element is evenly fixed on the first predetermined position of the first assembling table surface. The second vacuum adsorption platform has a second assembling table surface. When the second coupled element is adsorbed by the second vacuum adsorption platform according to vacuum adsorption, the second coupled element is evenly fixed on the second assembling table surface. After the first coupled element is evenly fixed on the first predetermined position of the first assembling table surface, the second vacuum adsorption platform is moved or rotated toward the first vacuum adsorption platform, so that the second coupled element is aligned with and placed on the first coupled element and combined with the first coupled element.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a portion of the conventional luminous keyboard;

FIG. 2 is a schematic exploded view illustrating a backlight module of the conventional luminous keyboard of FIG. 1;

FIG. 3 is a schematic exploded view illustrating the stock materials of the conventional backlight module;

FIG. 4 is a schematic cross-sectional view illustrating a portion of a backlight module according to an embodiment of the present invention;

FIG. 5 is a schematic exploded view illustrating the backlight module of FIG. 4;

FIG. 6 is a flowchart illustrating a backlight module assembling method according to an embodiment of the present invention;

FIG. 7 is a schematic exploded view illustrating the materials of the backlight module according to the embodiment of the present invention;

FIG. 8 is a schematic perspective view illustrating a portion of a backlight module assembling system according to a first embodiment of the present invention;

FIGS. 9A˜9G schematically illustrate the steps of a backlight module assembling method performed by the backlight module assembling system of FIG. 8;

FIG. 10 is a schematic perspective view illustrating a portion of a backlight module assembling system according to a second embodiment of the present invention;

FIGS. 11A˜11J schematically illustrate the steps of a backlight module assembling method performed by the backlight module assembling system of FIG. 10;

FIG. 12 is a schematic perspective view illustrating a portion of a backlight module assembling system according to a third embodiment of the present invention;

FIGS. 13A˜13J schematically illustrate the steps of a backlight module assembling method performed by the backlight module assembling system of FIG. 12; and

FIG. 14 is a schematic functional block diagram illustrating a portion of a backlight module assembling system according to a fourth embodiment of the present invention.

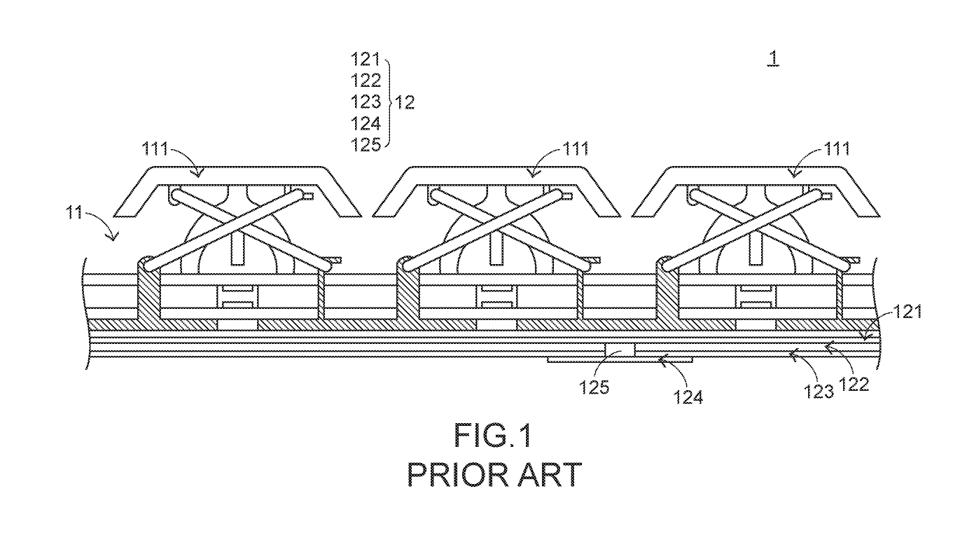

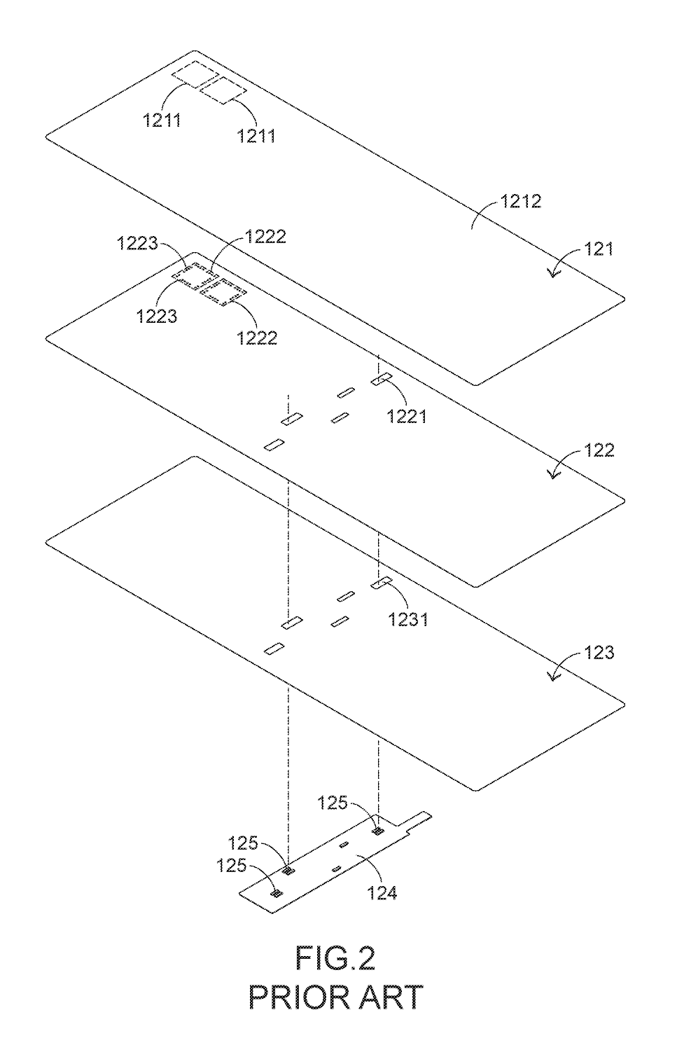

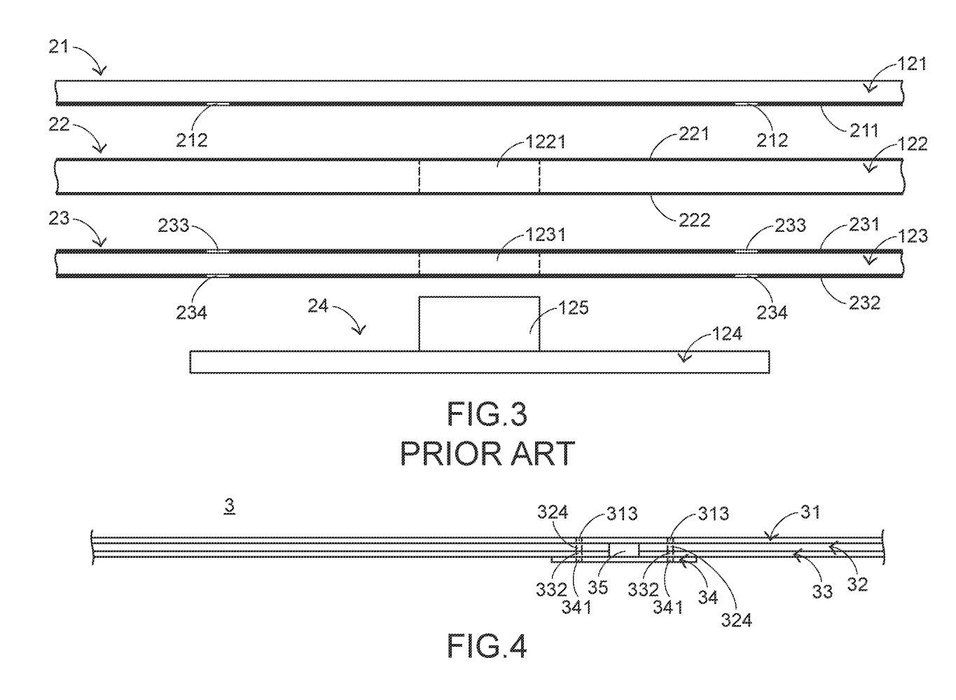

### DETAILED DESCRIPTION OF THE PREFERRED EMBODIMENT

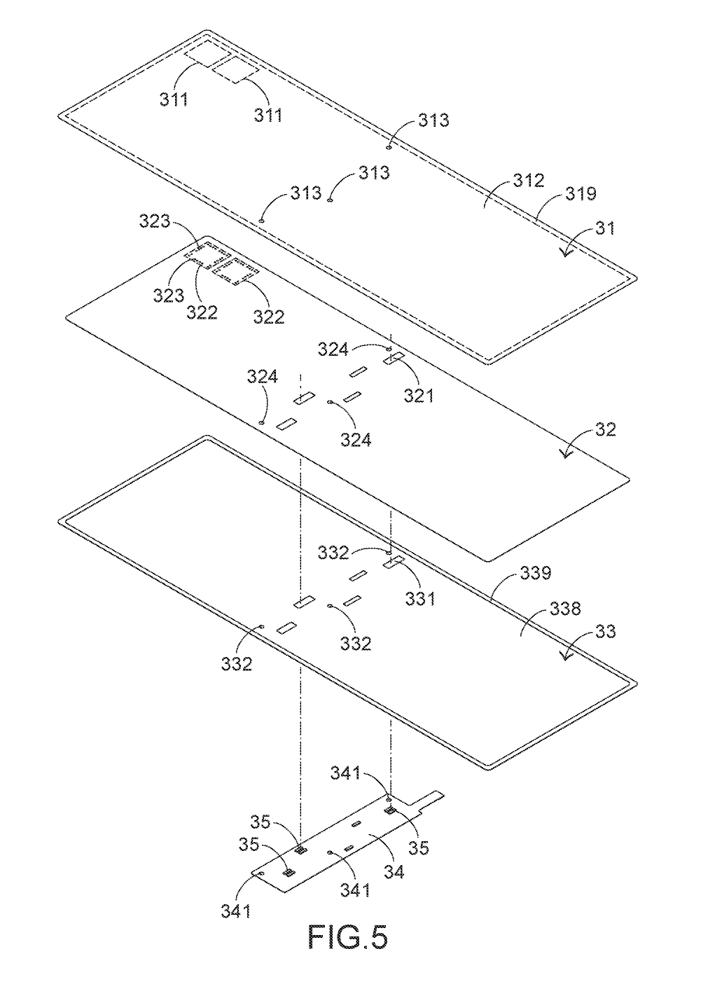

The present invention provides a backlight module assembling method. The backlight module assembling method is suitable for assembling a backlight module of a luminous keyboard. FIG. 4 is a schematic cross-sectional view illustrating a portion of a backlight module according to an embodiment of the present invention. FIG. 5 is a schematic exploded view illustrating the backlight module of FIG. 4. From top to bottom, the backlight module 3 comprises a light-shading plate 31, a light guide plate 32, a reflective plate 33, and a flexible circuit board 34 with a light source.

The light source comprises plural light emitting diodes 35. The reflective plate 33 has plural reflective plate openings 331 corresponding to the plural light emitting diodes 35. The light guide plate 32 has plural light guide plate openings 321 and plural light guide blocks 322. The plural light guide plate openings 321 are aligned with the corresponding light emitting diodes 35. For succinctness, only two light guide blocks 322 are shown in FIG. 5. It is noted that the number of the light guide blocks 322 is not restricted. The light guide blocks 322 are used for scattering the light beams upwardly. Generally, the plural light guide blocks 322 are aligned with corresponding keys (not shown) of the luminous keyboard (not shown). Each light guide block 322 is composed of several light guide dots 323. The light-shading plate 31 comprises plural light-transmissible regions 311 and a light-shading region 312. For succinctness, only two light-transmissible regions 311 are shown in FIG. 5. It is noted that the number of the light-transmissible regions 311 is not restricted. The plural light-transmissible regions 311 are aligned with the corresponding light guide blocks 322. The light-shading region 33 is arranged around the plural light-transmissible regions 311. Generally, the light-shading region 312 contains light-shading ink. Alternatively, the light-shading region 312 contains a reflective material for reflecting the light beam back to the light guide plate 32.

Moreover, after each light emitting diode 35 is penetrated from a bottom side of the reflective plate 33 and upwardly through the corresponding reflective plate opening 331 and the corresponding light guide plate opening 321 sequentially, the light emitting diode 35 is embedded within the backlight module 3. When electricity is provided to the flexible circuit board 34, the light source emits the light beams. After the light beams are introduced into the light guide plate 32, the light beams are diffused to the entire of the light guide plate 32. Due to the material properties of the light guide dots 323, the light beams are scattered upwardly or downwardly by the light guide dots 323. The portions of the light beams that are scattered upwardly will be transmitted through the corresponding light-transmissible regions 311 of the light-shading plate 31 and projected to the corresponding keys. The portions of the light beams that are scattered downwardly will be reflected back to the light guide plate 32 by the reflective plate 33. Consequently, the light beams provided by the light source can be well utilized to illuminate the plural keys. In such way, the function of the backlight module 3 can be achieved.

In comparison with the reflective plate 123 of the conventional backlight module, a peripheral region 339 at a top surface of the reflective plate 33 is slightly higher than a non-periphery 338 of the reflective plate 33. The non-periphery 338 of the reflective plate 33 is coupled with the light guide plate 32. The peripheral region 339 of the reflective plate 33 is coupled with a periphery region 319 at a bottom surface of the light-shading plate 31. Consequently, the light guide plate 32 is covered between the light-shading plate 31 and the reflective plate 33. In this way, the light beams are not leaked out from the lateral sides of the light guide plate 32, and the backlight module 3 is waterproof.

In the assembling method of the backlight module 3, any two adjacent coupled elements at the top side and the bottom side to be combined together comprises a first coupled element and a second coupled element. For example, the first coupled element and the second coupled element are the flexible circuit board 34 and the reflective plate 33, respectively. Alternatively, the first coupled element is the combination of the flexible circuit board 34 and the reflective plate 33, and the second coupled element is the combination of the light-shading plate 31 and the light guide plate 32. It is noted that the examples of the first coupled element and the second coupled element are not restricted.

Moreover, at least one of the first coupled element and the second coupled element is equipped with plural coupling objects. The first coupled element and the second coupled element are combined together through the plural coupling objects. In an embodiment, the coupling objects are colloidal glues. When the first coupled element and the second coupled element are contacted with each other, the first coupled element and the second coupled element are glued together naturally. The examples of the coupling objects are presented herein for purpose of illustration and description only. It is noted that the coupling objects may be varied according to the practical requirements. In another embodiment, the coupling objects comprise a protruding post and an indentation corresponding to the protruding post. The protruding post is disposed on the first coupled element, and the indentation is formed in the second coupled element. When the first coupled element and the second coupled element are contacted with each other and pressed, the protruding post of the first coupled element is inserted into the indentation of the second coupled element. Consequently, the first coupled element and the second coupled element are combined together.

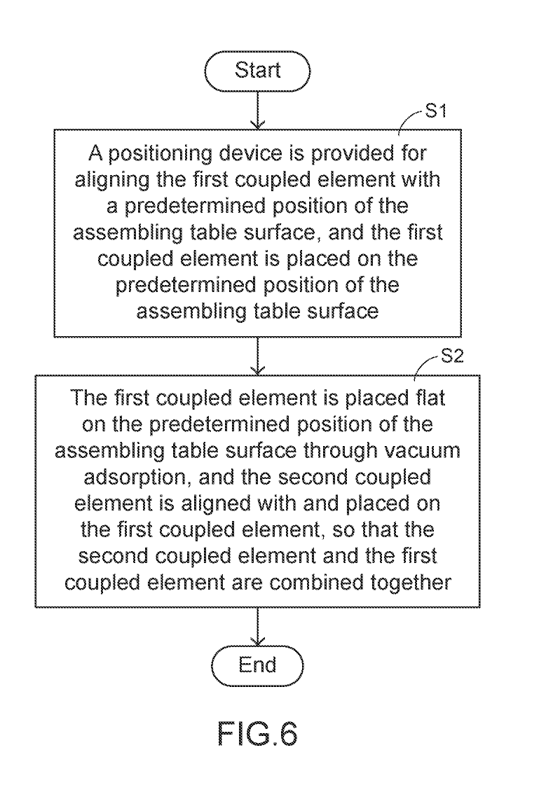

FIG. 6 is a flowchart illustrating a backlight module assembling method according to an embodiment of the present invention. As shown in FIG. 6, the two adjacent coupled elements at the top side and the bottom side (i.e., the first coupled element and the second coupled element) are combined together on an assembling table surface. The backlight module assembling method comprises the following steps. In a step S1, a positioning device is provided for aligning the first coupled element with a predetermined position of the assembling table surface, and the first coupled element is placed on the predetermined position of the assembling table surface. In a step S2, the first coupled element is placed flat on the predetermined position of the assembling table surface through vacuum adsorption, and the second coupled element is aligned with and placed on the first coupled element. Consequently, the second coupled element and the first coupled element are combined together. Preferably but not exclusively, the backlight module assembling method further comprises a step S3. After the second coupled element is aligned with and placed on the first coupled element, at least one specified position of the combination of the first coupled element and the second coupled element is pressed.

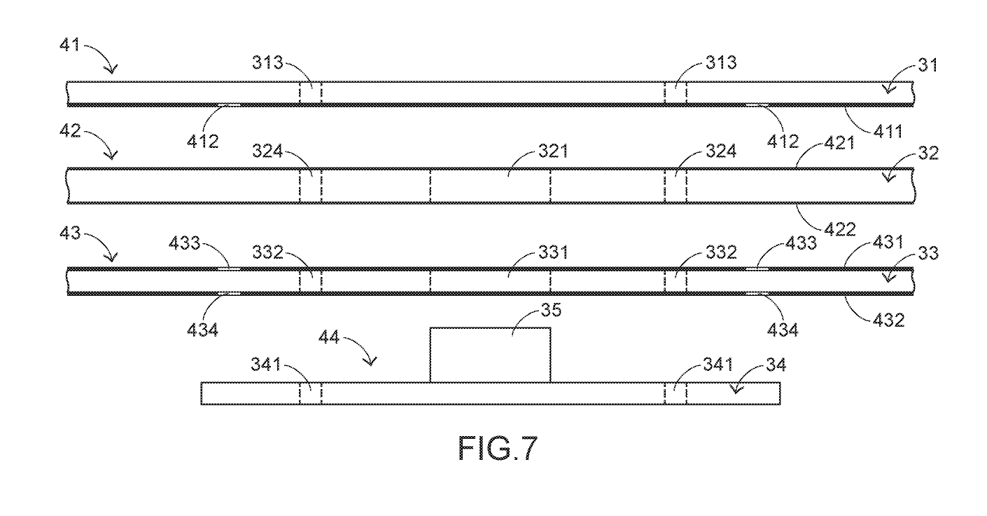

A backlight module assembling system using the backlight module assembling method of FIG. 6 will be illustrated as follows. The backlight module assembling system is applied to the production line of the backlight module 3. Firstly, the stock materials of plural coupled elements are prepared. The stock materials of the plural coupled elements include plural light-shading plate stock materials 41, plural light guide plate stock materials 42, plural reflective plate stock materials 43 and plural flexible circuit board stock materials 44. The stock materials of the backlight module are shown in FIG. 7.

Each light-shading plate stock material 41 comprises a light-shading plate 31, a protective film 411 and plural colloidal glues 412. The protective film 411 is attached on a bottom surface of the light-shading plate 31. The plural colloidal glues 412 are arranged between the bottom surface of the light-shading plate 31 and the protective film 411. Each light guide plate stock material 42 comprises a light guide plate 32, an upper protective film 421 and a lower protective film 422. The upper protective film 421 is attached on a top surface of the light guide plate 32. The lower protective film 422 is attached on a bottom surface of the light guide plate 32. Each reflective plate stock material 43 comprises a reflective plate 33, an upper protective film 431, a lower protective film 432, plural upper colloidal glues 433 and plural lower colloidal glues 434. The upper protective film 431 is attached on a top surface of the reflective plate 33. The lower protective film 432 is attached on a bottom surface of the reflective plate 33. The plural upper colloidal glues 433 are arranged between the top surface of the reflective plate 33 and the upper protective film 431. The plural lower colloidal glues 434 are arranged between the bottom surface of the reflective plate 33 and the lower protective film 432.

Preferably but not exclusively, each light-shading plate stock material 41 further comprises an additional protective film (not shown) and plural additional colloidal glues (not shown). The additional protective film is attached on a top surface of the light-shading plate 31. The additional colloidal glues are arranged between the top surface of the light-shading plate 31 and the additional protective film.

In comparison with the stock materials of the conventional stock materials, the stock materials of the coupled elements of the present invention have positioned structures to be positioned. In an embodiment, all positioned structures are positioned holes. For example, these positioned holes comprise light-shading plate holes 313, light guide plate holes 324, reflective plate holes 332 and flexible circuit board holes 341. The functions of these positioned holes will be described later. It is noted that the examples of the positioned structures are not restricted. That is, the examples of the positioned structures may be varied according to the practical requirements.

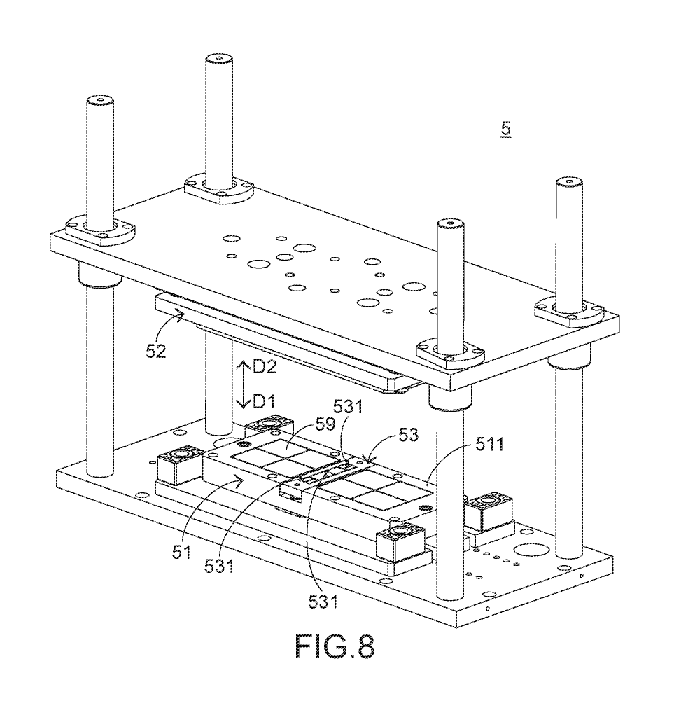

FIG. 8 is a schematic perspective view illustrating a portion of a backlight module assembling system according to a first embodiment of the present invention. The backlight module assembling system 5 comprises a first vacuum adsorption platform 51, a second vacuum adsorption platform 52, a first positioning device 53 and a pressing structure 59. The pressing structure 59 is disposed on the first vacuum adsorption platform 51 or located near the first vacuum adsorption platform 51. The first vacuum adsorption platform 51 comprises a first assembling table surface 511. The first positioning device 53 is used for aligning the first coupled element with a first predetermined position of the first assembling table surface 511 in order to assist in placing the first coupled element on the first assembling table surface 511. The first positioning device 53 is also used for the aligning the second coupled element with the first predetermined position of the first assembling table surface 511 in order for assisting in placing the second coupled element on the assembling table surface. When the first coupled element or the second coupled element is placed on the first predetermined position of the first assembling table surface 511, the first coupled element or the second coupled element is adsorbed by the first vacuum adsorption platform 51 according to vacuum adsorption. That is, the first vacuum adsorption platform 51 provides a negative pressure environment to the first coupled element or the second coupled element that is placed on the first predetermined position of the first assembling table surface 511. In response to the atmospheric pressure, the first coupled element or the second coupled element is evenly fixed on the first predetermined position of the first assembling table surface 511. Consequently, the first coupled element or the second coupled element is not wrinkled or upturned. The vacuum adsorption technology is well known to those skilled in the art, and is not redundantly described herein.

In this embodiment, the first positioning device 53 comprises plural positioning posts 531. These positioning posts 531 are disposed on the first assembling table surface 511. Moreover, the positions of these positioning posts 531 are determined according to the first predetermined position of the first assembling table surface 511. After the first positioned holes of the first coupled element or the second positioned holes of the second coupled element are sheathed around the corresponding positioning posts 531, the first coupled element or the second coupled element is aligned with the first predetermined position of the first assembling table surface 511. It is noted that the example of the first positioning device 53 is not restricted. That is, the examples of the first positioning device 53 may be varied according to the practical requirements. For example, the first positioning device 53 is an automatic optical inspection (AOI) device for positioning any coupled element according to an automatic optical inspection (AOI) technology.

The second vacuum adsorption platform 52 is disposed over the first vacuum adsorption platform 51. The second vacuum adsorption platform 52 is movable relative to the first vacuum adsorption platform 51 in a vertical direction. The second vacuum adsorption platform 52 comprises a second assembling table surface 521. The second vacuum adsorption platform 52 is used for adsorbing the second coupled element according to vacuum adsorption. That is, the second vacuum adsorption platform 52 provides a negative pressure environment to the second coupled element. In response to the atmospheric pressure, the second coupled element is evenly fixed on the second assembling table surface 521. The vacuum adsorption technology is well known to those skilled in the art, and is not redundantly described herein.

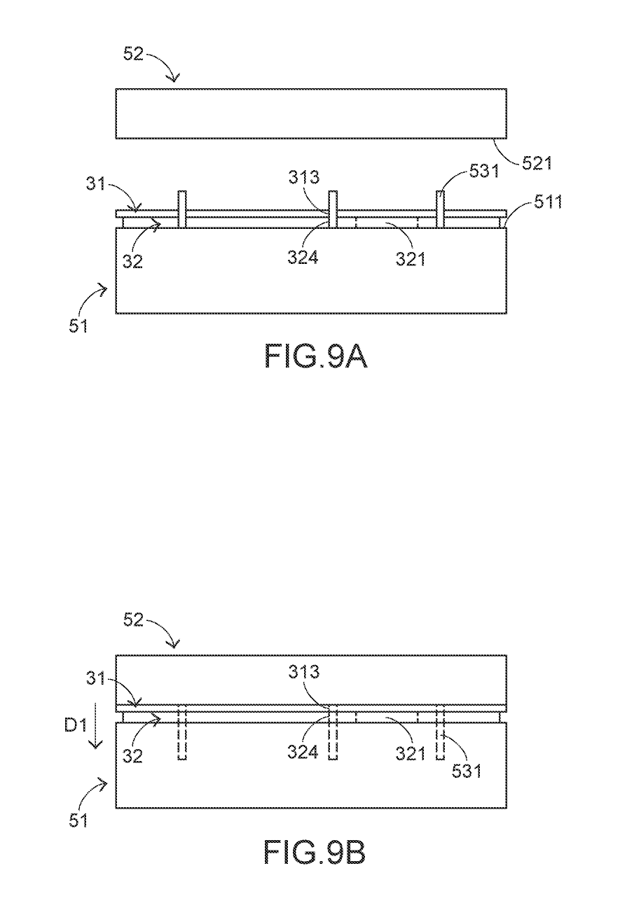

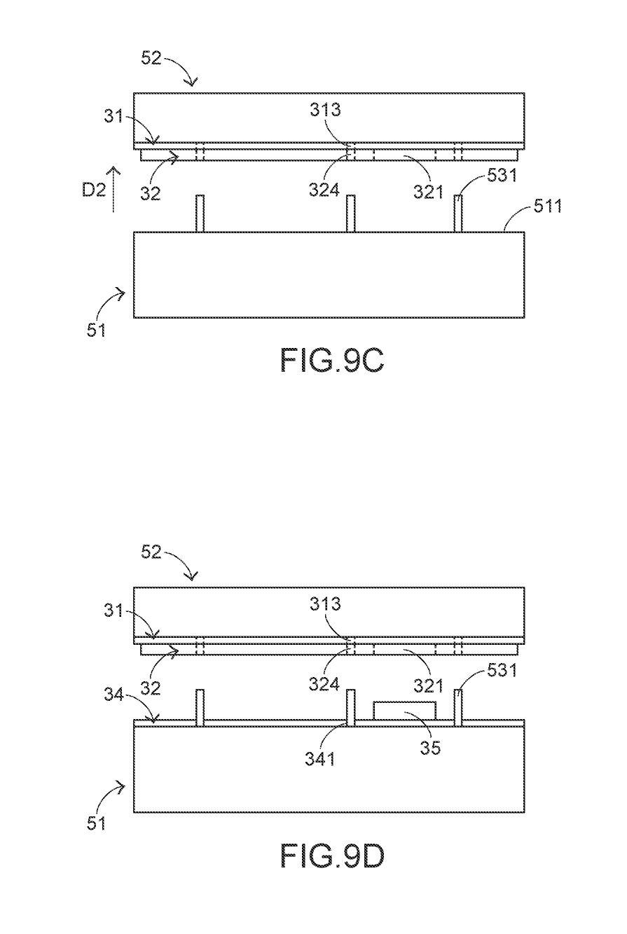

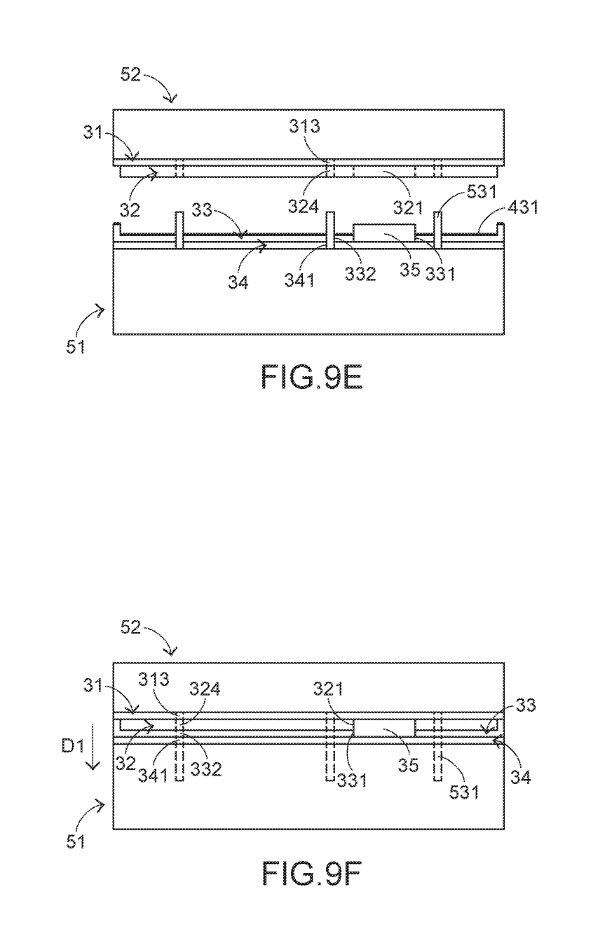

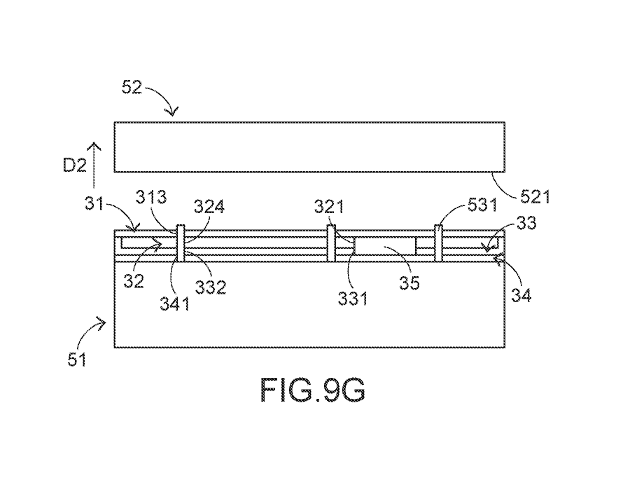

Hereinafter, the use of the backlight module assembling system 5 of FIG. 8 to assemble the backlight module 3 in the production line will be illustrated with reference to FIGS. 9A˜9G FIGS. 9A˜9G schematically illustrate the steps of a backlight module assembling method performed by the backlight module assembling system of FIG. 8. For succinctness, only portions of the backlight module assembling system 5, the light-shading plate stock materials 41, the light guide plate stock materials 42, the reflective plate stock materials 43 and the flexible circuit board stock materials 44 are shown in FIGS. 9A˜9G. It is noted that the steps of the backlight module assembling method performed by the backlight module assembling system are not restricted to the steps of FIGS. 9A-9G. However, the steps of the backlight module assembling method may be varied according to the practical requirements.

Please refer to FIG. 9A. Firstly, the second positioned holes of the second coupled element are aligned with the corresponding positioning posts 531 on the first assembling table surface 511 by the assembling worker. Then, the second positioned holes are sheathed around the corresponding positioning posts 531. Consequently, the second coupled element is correspondingly placed on the first predetermined position of the first assembling table surface 511. After the second coupled element is placed on the first assembling table surface 511, the second coupled element is adsorbed by the first vacuum adsorption platform 51 according to vacuum adsorption. Consequently, the second coupled element is evenly fixed on the first assembling table surface 511. In FIG. 9A, the second coupled element is the combination of the light-shading plate 31 and the light guide plate 32, wherein the lower protective film 422 of the light guide plate stock material 42 is removed. Moreover, the second positioned holes as shown in FIG. 9A comprise the light-shading plate holes 313 and the light guide plate holes 324.

Please refer to FIG. 9B. After the second coupled element is evenly fixed on the first assembling table surface 511, the second vacuum adsorption platform 52 is moved downwardly relative to the first vacuum adsorption platform 51 in a vertical direction (i.e., the direction D1). Consequently, the second assembling table surface 521 is contacted with the second coupled element.

Please refer to FIG. 9C. After the second assembling table surface 521 of the second vacuum adsorption platform 52 is contacted with the second coupled element, the second coupled element is adsorbed by the second vacuum adsorption platform 52 according to vacuum adsorption. Then, the second vacuum adsorption platform 52 is moved upwardly relative to the first vacuum adsorption platform 51 in the vertical direction (i.e., the direction D2). Consequently, the second coupled element is moved away from the first vacuum adsorption platform 51.

Please refer to FIG. 9D. After the second vacuum adsorption platform 52 is moved upwardly relative to the first vacuum adsorption platform 51 in the vertical direction and the second coupled element is moved away from the first vacuum adsorption platform 51, the flexible circuit board holes 341 of the flexible circuit board 34 are aligned with the corresponding positioning posts 531 on the first assembling table surface 511 by the assembling worker. Then, the flexible circuit board holes 341 of the flexible circuit board 34 are sheathed around the corresponding positioning posts 531. Consequently, the flexible circuit board 34 is correspondingly placed on the first predetermined position of the first assembling table surface 511. After the flexible circuit board 34 is placed on the first assembling table surface 511, the flexible circuit board 34 is adsorbed by the first vacuum adsorption platform 51 according to vacuum adsorption. Consequently, the flexible circuit board 34 is evenly fixed on the first assembling table surface 511.

Please refer to FIG. 9E. After the flexible circuit board 34 is evenly fixed on the first predetermined position of the first assembling table surface 511, the lower protective film 432 of the reflective plate stock material 43 is removed by the assembling worker. Then, the reflective plate holes 332 of the reflective plate stock material 43 are aligned with the corresponding positioning posts 531 on the first assembling table surface 511. Then, the reflective plate holes 332 of the reflective plate stock material 43 are sheathed around the corresponding positioning posts 531. Consequently, the reflective plate stock material 43 is correspondingly placed on the flexible circuit board 34. Since plural lower colloidal glues 434 are disposed on the bottom surface of the reflective plate 33, the flexible circuit board 34 and the reflective plate 33 are glued together through the lower colloidal glues 434. After the flexible circuit board 34 and the reflective plate 33 are combined together, the flexible circuit board 34 and the reflective plate 33 are precisely aligned with each other. For example, all light emitting diodes 35 of the light source on the flexible circuit board 34 are precisely penetrated through the corresponding reflective plate openings 331 of the reflective plate 33.

In the steps of FIGS. 9D and 9E, the flexible circuit board 34 and the reflective plate 33 are respectively equivalent to the first coupled element and the second coupled element as described in the flowchart of FIG. 6. That is, the steps of FIGS. 9D and 9E are also the examples of the assembling method of FIG. 6. After the flexible circuit board 34 and the reflective plate 33 are combined together, the combination of the flexible circuit board 34 and the reflective plate 33 may be considered as the first coupled element of FIG. 8.

Please refer to FIG. 9F. After the flexible circuit board 34 and the reflective plate 33 are combined together, the upper protective film 431 of the reflective plate stock material 43 is removed by the assembling worker. Then, the second vacuum adsorption platform 52 is moved downwardly relative to the first vacuum adsorption platform 51 in the vertical direction (i.e., the direction D1). Consequently, the second coupled element is contacted with the top surface of the reflective plate 33. Since plural upper colloidal glues 433 are disposed on the top surface of the reflective plate 33, the first coupled element and the second coupled element are glued together through the upper colloidal glues 433. After the first coupled element and the second coupled element are combined together, the first coupled element and the second coupled element are precisely aligned with each other. For example, all light emitting diodes 35 of the light source on the flexible circuit board 34 are precisely penetrated through the corresponding light guide plate openings 321 of the light guide plate 32.

After the first coupled element and the second coupled element are combined together, the combination of the first coupled element and the second coupled element is pressed by the pressing structure 59. Consequently, any two adjacent elements of the backlight module 3 at the top side and the bottom side can be securely combined together. In an embodiment, the positions of the backlight module 3 to be pressed by the pressing structure 59 are aligned with the corresponding upper colloidal glues 433 and the corresponding lower colloidal glues 434. For example, the peripheral region 339 at the top surface of the reflective plate 33 is an important position for installing the colloidal glues 433. Consequently, before the second vacuum adsorption platform 52 is moved upwardly relative to the first vacuum adsorption platform 51 in the vertical direction (i.e., the direction D2), the pressing structure 59 is moved upwardly to press the peripheral region 339 at the top surface of the reflective plate 33. Consequently, the light guide plate 32 is covered between the light-shading plate 31 and the reflective plate 33. In this way, the light beams are not leaked out from the lateral sides of the light guide plate 32, and the backlight module 3 is waterproof.

Please refer to FIG. 9G. After the combination of the first coupled element and the second coupled element is pressed by the pressing structure 59, the second vacuum adsorption platform 52 is moved upwardly relative to the first vacuum adsorption platform 51 in the vertical direction (i.e., the direction D2) again. Then, the combination of the first coupled element and the second coupled element is removed from the first vacuum adsorption platform 51 by the assembling worker. Consequently, the assembling process of the backlight module 3 is completed. Preferably but not exclusively, the first vacuum adsorption platform 51 further comprises a push structure (not shown). After the backlight module 3 is assembled, the push structure pushes the backlight module 3 from bottom to top. Consequently, the backlight module 3 can be removed from the first vacuum adsorption platform 51 more easily.

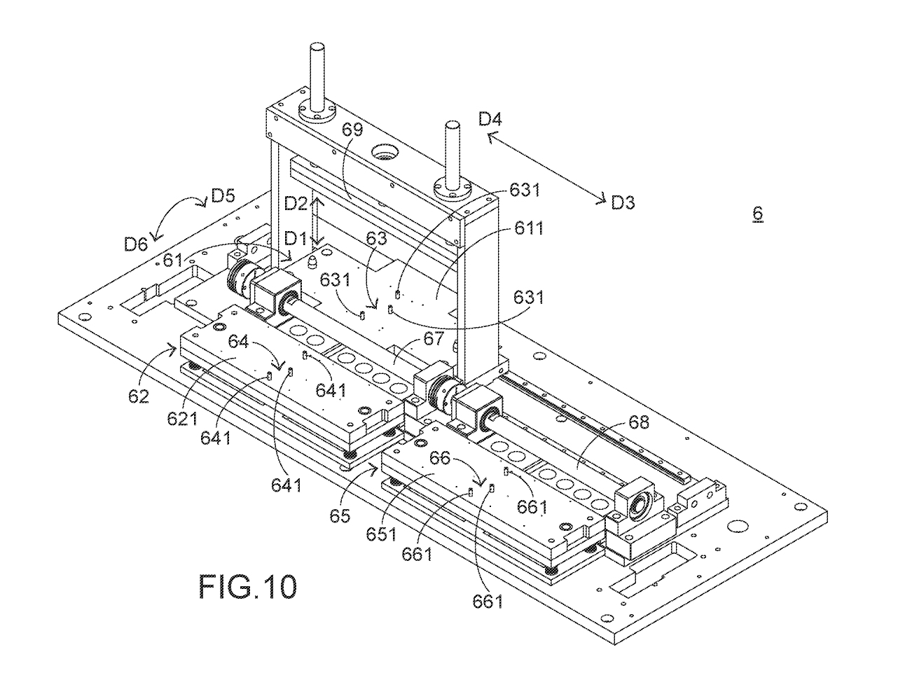

FIG. 10 is a schematic perspective view illustrating a portion of a backlight module assembling system according to a second embodiment of the present invention. Since the components of the backlight module assembling system 6 of this embodiment are substantially identical to those of the first embodiment, only the distinguished aspects will be described as follows. The backlight module assembling system 6 comprises a first vacuum adsorption platform 61 with a first assembling table surface 611, a second vacuum adsorption platform 62 with a second assembling table surface 621, a third vacuum adsorption platform 65 with a third assembling table surface 651, a first positioning device 63, a second positioning device 64, a third positioning device 66 and a pressing structure 69. The pressing structure 69 is disposed over the first vacuum adsorption platform 61 and movable relative to the first vacuum adsorption platform 61 in a vertical direction. The first positioning device 63 is used for aligning the flexible circuit board 34 with a first predetermined position of the first assembling table surface 611 in order to assist in placing the flexible circuit board 34 on the assembling table surface 611. When the flexible circuit board 34 or the combination of the flexible circuit board 34 and the reflective plate 33 is placed on the first predetermined position of the first assembling table surface 611, the flexible circuit board 34 or the combination of the flexible circuit board 34 and the reflective plate 33 is adsorbed by the first vacuum adsorption platform 61 according to vacuum adsorption.

Moreover, the second positioning device 64 is used for aligning the reflective plate 33 with a second predetermined position of the second assembling table surface 621 in order to assist in placing the reflective plate 33 on the second assembling table surface 621. When the reflective plate 33 is placed on the second predetermined position of the second assembling table surface 621, the reflective plate 33 is adsorbed by the second vacuum adsorption platform 62 according to vacuum adsorption.

Moreover, the third positioning device 66 is used for aligning the light-shading plate 31 with a third predetermined position of the third assembling table surface 651 in order to assist in placing the light-shading plate 31 on the third assembling table surface 651. When the light-shading plate 31 or the combination of the light-shading plate 31 and the light guide plate 32 is placed on the third predetermined position of the third assembling table surface 651, the light-shading plate 31 or the combination of the light-shading plate 31 and the light guide plate 32 is adsorbed by the third vacuum adsorption platform 63 according to vacuum adsorption. For facilitating the subsequent aligning procedures, the second predetermined position and the third predetermined position are determined according to the first predetermined position. The reason will be described later.

In this embodiment, the first positioning device 63 comprises plural positioning posts 631 on the first assembling table surface 611. Moreover, the positions of these positioning posts 631 are determined according to the first predetermined position of the first assembling table surface 611. Similarly, the second positioning device 64 comprises plural positioning posts 641 on the second assembling table surface 621. Moreover, the positions of these positioning posts 641 are determined according to the second predetermined position of the second assembling table surface 621. Similarly, the third positioning device 66 comprises plural positioning posts 661 on the third assembling table surface 651. Moreover, the positions of these positioning posts 661 are determined according to the third predetermined position of the third assembling table surface 651. It is noted that the examples of the first positioning device 63, the second positioning device 64 and the third positioning device 66 are not restricted. That is, the examples of the first positioning device 63, the second positioning device 64 and the third positioning device 66 may be varied according to the practical requirements. For example, the first positioning device 63, the second positioning device 64 or the third positioning device 66 is an automatic optical inspection (AOI) device for positioning any coupled element according to an automatic optical inspection (AOI) technology.

In this embodiment, the first vacuum adsorption platform 61 and the pressing structure 69 over the first vacuum adsorption platform 61 are movable between a first position near the second vacuum adsorption platform 62 and a second position near the third vacuum adsorption platform 65 in a reciprocating manner.

The backlight module assembling system 6 further comprises a first rotating shaft 67 and a second rotating shaft 68. The first rotating shaft 67 is connected with the second vacuum adsorption platform 62. The second rotating shaft 68 is connected with the third vacuum adsorption platform 65. Consequently, the second vacuum adsorption platform 62 is rotated with the first rotating shaft 67, and the third vacuum adsorption platform 65 is rotated with the second rotating shaft 68.

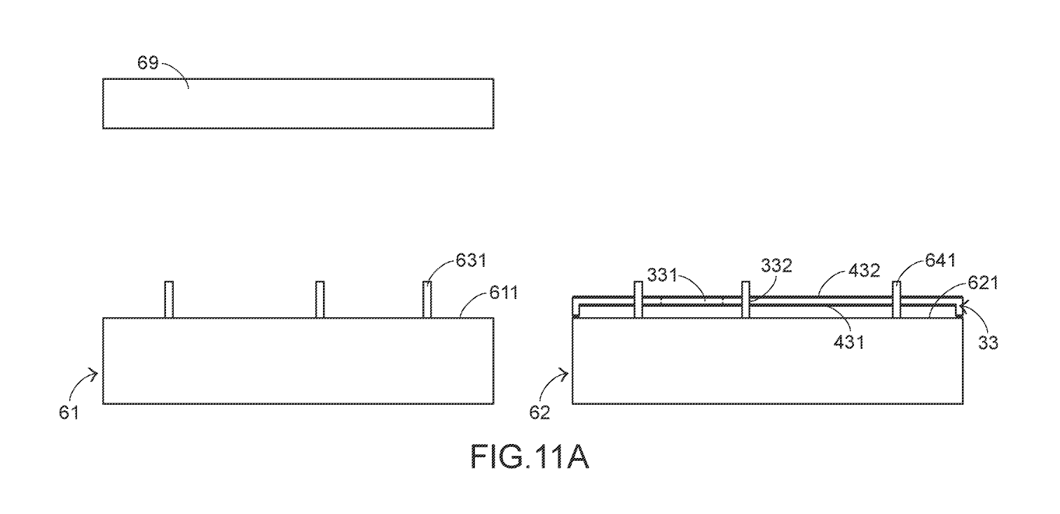

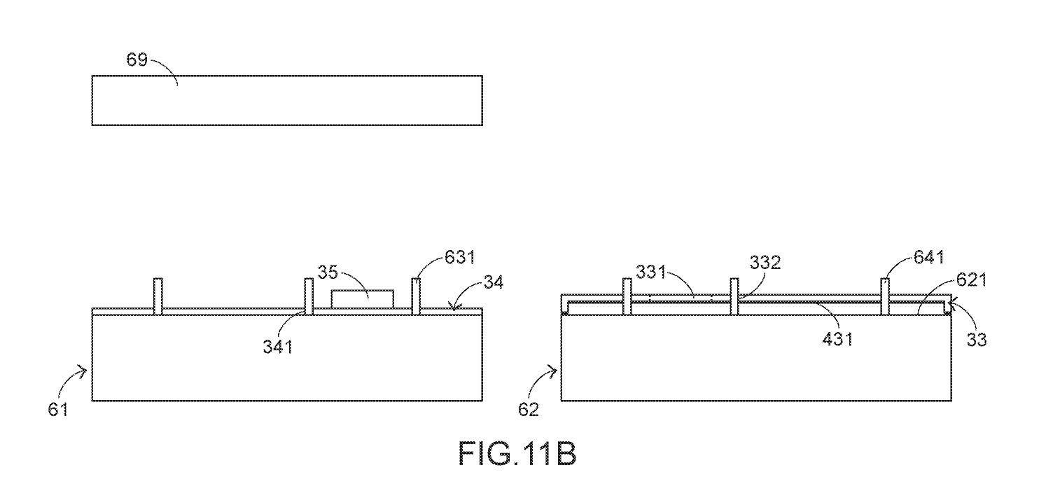

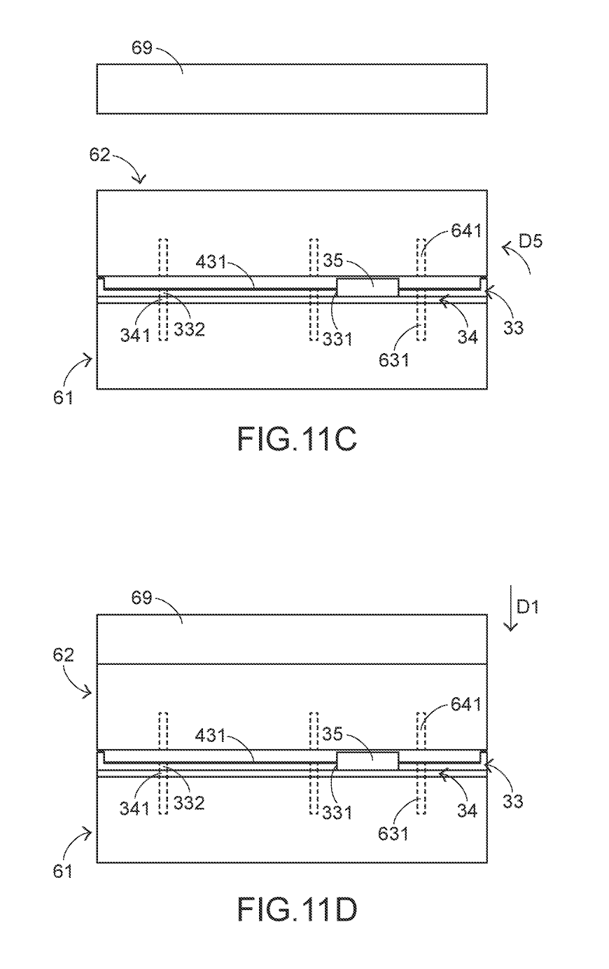

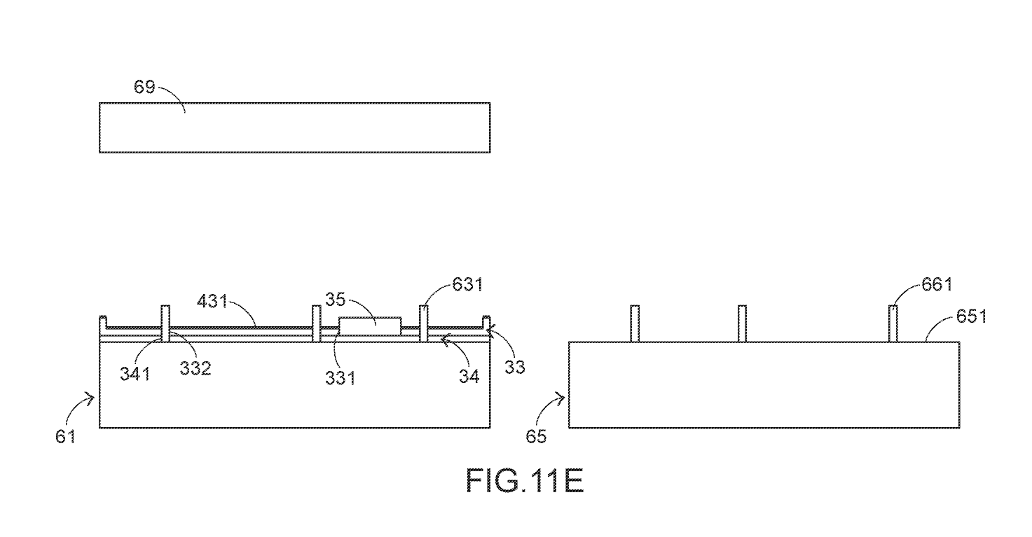

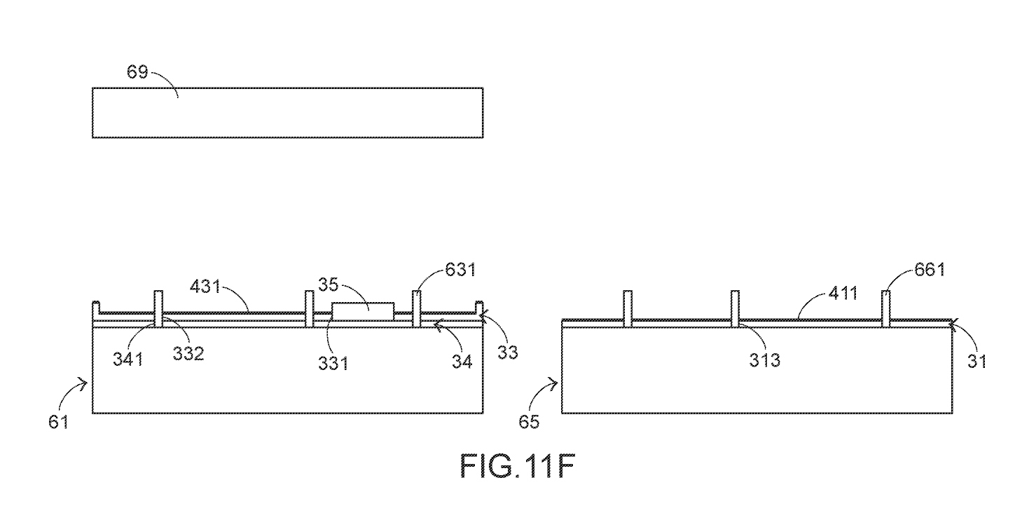

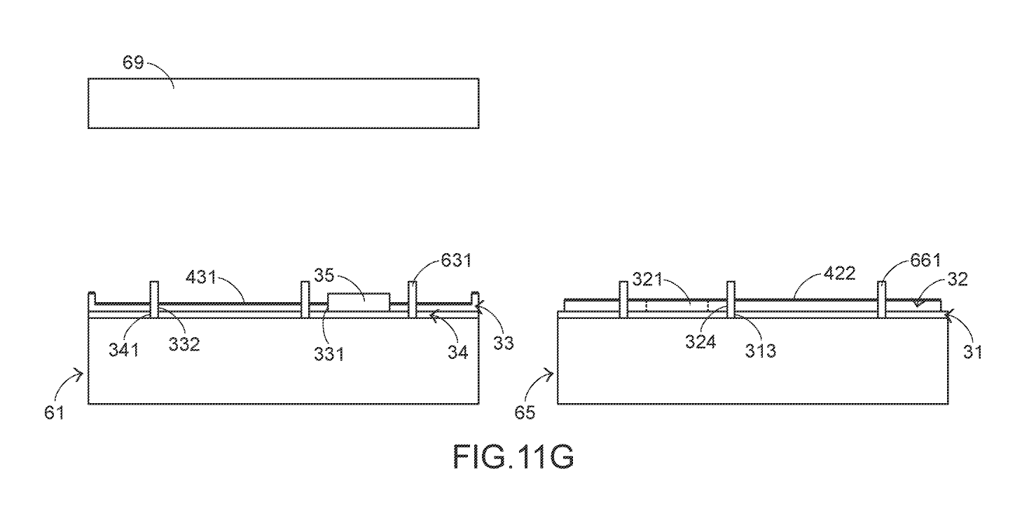

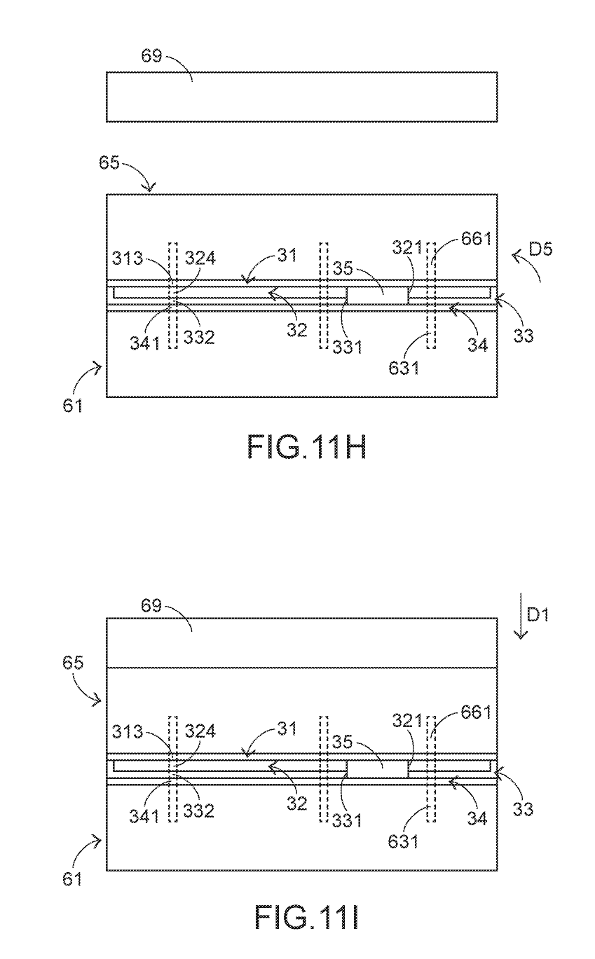

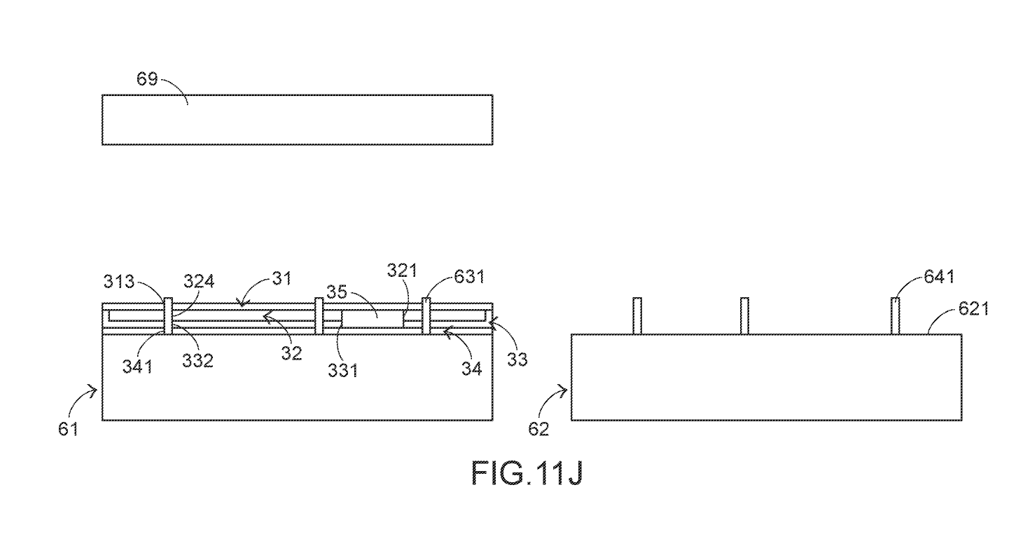

Hereinafter, the use of the backlight module assembling system 6 of FIG. 10 to assemble the backlight module 3 in the production line will be illustrated with reference to FIGS. 11A˜11J. FIGS. 11A˜11J schematically illustrate the steps of a backlight module assembling method performed by the backlight module assembling system of FIG. 10. For succinctness, only portions of the backlight module assembling system 6, the light-shading plate stock materials 41, the light guide plate stock materials 42, the reflective plate stock materials 43 and the flexible circuit board stock materials 44 are shown in FIGS. 11A˜11J. It is noted that the steps of the backlight module assembling method performed by the backlight module assembling system are not restricted to the steps of FIGS. 11A˜11J. However, the steps of the backlight module assembling method may be varied according to the practical requirements.

As shown in FIG. 11A, the backlight module assembling system 6 is in an initial status. In the initial status, the first vacuum adsorption platform 61 and the pressing structure 69 over the first vacuum adsorption platform 61 are located near the second vacuum adsorption platform 62. Firstly, the top surface of the reflective plate 33 faces the second assembling table surface 621. Then, the reflective plate holes 332 of the reflective plate stock material 43 are aligned with the corresponding positioning posts 641 on the second assembling table surface 621. Then, the reflective plate holes 332 of the reflective plate stock material 43 are sheathed around the corresponding positioning posts 641. Consequently, the reflective plate stock material 43 is correspondingly placed on the second predetermined position of the second assembling table surface 621. After the reflective plate 33 is placed on the second assembling table surface 621, the reflective plate 33 is adsorbed by the second vacuum adsorption platform 62 according to vacuum adsorption. Consequently, the reflective plate 33 is evenly fixed on the second predetermined position of the second assembling table surface 621.

Please refer to FIG. 11B. After the reflective plate 33 is evenly fixed on the second predetermined position of the second assembling table surface 621, the lower protective film 432 of the reflective plate stock material 43 is removed by the assembling worker. Then, the flexible circuit board holes 341 of the flexible circuit board 34 are aligned with the corresponding positioning posts 631 on the first assembling table surface 611 by the assembling worker. Then, the flexible circuit board holes 341 of the flexible circuit board 34 are sheathed around the corresponding positioning posts 631. Consequently, the flexible circuit board 34 is correspondingly placed on the first predetermined position of the first assembling table surface 611. After the flexible circuit board 34 is placed on the first assembling table surface 611, the flexible circuit board 34 is adsorbed by the first vacuum adsorption platform 61 according to vacuum adsorption. Consequently, the flexible circuit board 34 is evenly fixed on the first predetermined position of the first assembling table surface 611. The step of FIG. 11A and the step of FIG. 11B may be exchanged according to the practical requirements.

Please refer to FIG. 11C. After the step of FIG. 11A and the step of FIG. 11B are performed, the first rotating shaft 67 is driven to rotate. Consequently, the second vacuum adsorption platform 62 is rotated toward the first vacuum adsorption platform 61 in the direction D5. Meanwhile, the bottom surface of the reflective plate 33 is contacted with the flexible circuit board 34. Since plural lower colloidal glues 434 are disposed on the bottom surface of the reflective plate 33, the flexible circuit board 34 and the reflective plate 33 are glued together through the lower colloidal glues 434. Moreover, since the second predetermined position of the second assembling table surface 621 corresponds to the first predetermined position of the first assembling table surface 611, the reflective plate 33 and the flexible circuit board 34 are precisely aligned with each other. For example, all light emitting diodes 35 of the light source on the flexible circuit board 34 are precisely penetrated through the corresponding reflective plate openings 331 of the reflective plate 33.

In the steps of FIGS. 11A, 11B and 11C, the flexible circuit board 34 and the reflective plate 33 are respectively equivalent to the first coupled element and the second coupled element as described in the flowchart of FIG. 6. That is, the steps of FIGS. 11A, 11B and 11C are also the examples of the assembling method of FIG. 6.

Please refer to FIG. 11D. After the reflective plate 33 and the flexible circuit board 34 are combined together, the second vacuum adsorption platform 62 is not rotated away from the first vacuum adsorption platform 61 to the original position in the direction D6 in response to the rotation of the first rotating shaft 67. Meanwhile, the pressing structure 69 over the first vacuum adsorption platform 61 is moved downwardly relative to the first vacuum adsorption platform 61 in a vertical direction (i.e., the direction D1). Consequently, the second vacuum adsorption platform 62 is contacted with and pressed by the pressing structure 69. Since the combination of the reflective plate 33 and the flexible circuit board 34 is pressed by the pressing structure 69, the reflective plate 33 and the flexible circuit board 34 are combined together more securely. In this embodiment, the positions of the backlight module 3 to be pressed by the pressing structure 69 are aligned with the corresponding lower colloidal glues 434.

Please refer to FIG. 11E. After the combination of the reflective plate 33 and the flexible circuit board 34 is pressed by the pressing structure 69, the pressing structure 69 is moved upwardly relative to the first vacuum adsorption platform 61 in the vertical direction (i.e., the direction D2). Then, the first rotating shaft 67 is driven to rotate. Consequently, the second vacuum adsorption platform 62 is rotated away from the first vacuum adsorption platform 61 to the original position in the direction D6. Then, the first vacuum adsorption platform 61 and the pressing structure 69 over the first vacuum adsorption platform 61 are moved to the position near the third vacuum adsorption platform 65 in the direction D3.

Please refer to FIG. 11F. The top surface of the light-shading plate 31 faces the third assembling table surface 651. Then, the light-shading plate holes 313 of the light-shading plate stock material 41 are aligned with the corresponding positioning posts 661 on the third assembling table surface 651. Then, the light-shading plate holes 313 of the light-shading plate stock material 41 are sheathed around the corresponding positioning posts 661. Consequently, the light-shading plate stock material 41 is correspondingly placed on the third predetermined position of the third assembling table surface 651. After the light-shading plate 31 is placed on the third assembling table surface 651, the light-shading plate 31 is adsorbed by the third assembling table surface 651 according to vacuum adsorption. Consequently, the light-shading plate 31 is evenly fixed on the third predetermined position of the third assembling table surface 651. For reducing the time period of assembling the backlight module 3, the step of FIG. 11F and the step of FIG. 11F may be simultaneously performed according to practical requirements.

Please refer to FIG. 11G. After the light-shading plate 31 is evenly fixed on the third predetermined position of the third assembling table surface 651, the protective film 411 of the light-shading plate stock material 41 by the assembling worker. Then, the upper protective film 421 of the light guide plate stock material 42 is removed, and the top surface of the light guide plate 32 faces the third assembling table surface 651. Then, the light guide plate holes 324 of the light guide plate stock material 42 are aligned with the corresponding positioning posts 661 on the third assembling table surface 651. Then, the light guide plate holes 324 of the light guide plate stock material 42 are sheathed around the corresponding positioning posts 661. Consequently, the light guide plate 32 is placed on the light-shading plate 31. Since plural colloidal glues 412 are disposed on the bottom surface of the light-shading plate 31, the light-shading plate 31 and the light guide plate 32 are glued together through the colloidal glues 412. Meanwhile, the combination of the light-shading plate 31 and the light guide plate 32 is adsorbed by the third vacuum adsorption platform 65 according to vacuum adsorption.

In the steps of FIGS. 11F and 11G the light-shading plate 31 and the light guide plate 32 are respectively equivalent to the first coupled element and the second coupled element as described in the flowchart of FIG. 6. That is, the steps of FIGS. 11F and 11G are also the examples of the assembling method of FIG. 6.

Please refer to FIG. 11H. After the steps of FIG. 11E-11G are performed, the lower protective film 422 of the light guide plate stock material 42 and the upper protective film 431 of the reflective plate stock material 43 are removed by the assembling worker. Then, the second rotating shaft 68 is driven to rotate. Consequently, the third vacuum adsorption platform 65 is rotated toward the first vacuum adsorption platform 61 in the direction D5. Meanwhile, the bottom surface of the light guide plate 32 and the non-periphery 338 at the top surface of the reflective plate 33 are contacted with each other, and the periphery region 319 at a bottom surface of the light-shading plate 31 and the peripheral region 339 at the top surface of the reflective plate 33 are contacted with each other. As mentioned above, plural upper colloidal glues 433 are disposed on the top surface of the reflective plate 33. Consequently, the non-periphery 338 at the top surface of the reflective plate 33 and the light guide plate 32 are glued together through the upper colloidal glues 433, and the peripheral region 339 at the top surface of the reflective plate 33 and the light-shading plate 31 are glued together through the upper colloidal glues 433. Moreover, the third predetermined position of the third assembling table surface 651 corresponds to the first predetermined position of the first assembling table surface 611. Consequently, the light-shading plate 31, the light guide plate 32, the reflective plate 33 and the flexible circuit board 34 are precisely aligned with each other. For example, all light emitting diodes 35 of the light source on the flexible circuit board 34 are precisely penetrated through the corresponding light guide plate openings 321 of the light guide plate 32.

In the step 11H, the combination of the reflective plate 33 and the flexible circuit board 34 is equivalent to the first coupled element as described in the flowchart of FIG. 6, and the combination of the light-shading plate 31 and the light guide plate 32 is equivalent to the second coupled element as described in the flowchart of FIG. 6. That is, the step of 11H is also the example of the assembling method of FIG. 6.

Please refer to FIG. 11I. After the flexible circuit board 34, the reflective plate 33, the light guide plate 32 and the light-shading plate 31 are combined together, the third vacuum adsorption platform 65 is not rotated away from the first vacuum adsorption platform 61 to the original position in the direction D6 in response to the rotation of the second rotating shaft 68. Meanwhile, the pressing structure 69 over the first vacuum adsorption platform 61 is moved downwardly relative to the first vacuum adsorption platform 61 in the vertical direction (i.e., the direction D1). Consequently, the third vacuum adsorption platform 65 is contacted with and pressed by the pressing structure 69. Since the combination of the flexible circuit board 34, the reflective plate 33, the light guide plate 32 and the light-shading plate 31 is pressed by the pressing structure 69, the flexible circuit board 34, the reflective plate 33, the light guide plate 32 and the light-shading plate 31 are combined together more securely.

In an embodiment, the positions of the backlight module 3 to be pressed by the pressing structure 69 are aligned with the corresponding colloidal glues 412, 433 and 434. For example, the peripheral region 339 at the top surface of the reflective plate 33 is an important position for installing the colloidal glues 433. That is, the pressing structure 69 is moved downwardly to press the peripheral region 339 at the top surface of the reflective plate 33. Consequently, the light guide plate 32 is covered between the light-shading plate 31 and the reflective plate 33. In this way, the light beams are not leaked out from the lateral sides of the light guide plate 32, and the backlight module 3 is waterproof.

Please refer to FIG. 11J. After the flexible circuit board 34, the reflective plate 33, the light guide plate 32 and the light-shading plate 31 are combined together, the pressing structure 69 is moved upwardly relative to the first vacuum adsorption platform 61 in the vertical direction. Then, the second rotating shaft 68 is driven to rotate. Consequently, the third vacuum adsorption platform 65 is rotated away from the first vacuum adsorption platform 61 to the original position in the direction D6. Then, the first vacuum adsorption platform 61 and the pressing structure 69 over the first vacuum adsorption platform 61 are moved from the position near the third vacuum adsorption platform 65 to the position near the second vacuum adsorption platform 62 in the direction D4. Then, the combination of the flexible circuit board 34, the reflective plate 33, the light guide plate 32 and the light-shading plate 31 is removed from the first vacuum adsorption platform 61 by the assembling worker. Consequently, the assembling process of the backlight module 3 is completed. Preferably but not exclusively, the first vacuum adsorption platform 61 further comprises a push structure (not shown). After the backlight module 3 is assembled, the push structure pushes the backlight module 3 from bottom to top. Consequently, the backlight module 3 can be removed from the first vacuum adsorption platform 61 more easily.

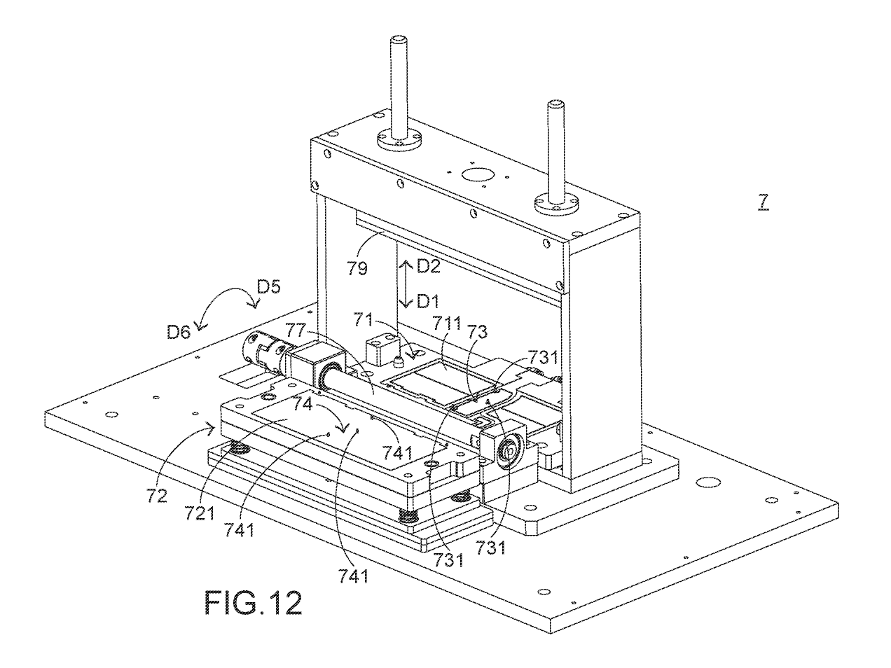

FIG. 12 is a schematic perspective view illustrating a portion of a backlight module assembling system according to a third embodiment of the present invention. Since the components of the backlight module assembling system 7 of this embodiment are substantially identical to those of the second embodiment, only the distinguished aspects will be described as follows. The backlight module assembling system 7 comprises a first vacuum adsorption platform 71 with a first assembling table surface 711, a second vacuum adsorption platform 72 with a second assembling table surface 721, a first positioning device 73, a second positioning device 74 and a pressing structure 79. The pressing structure 79 is disposed over the first vacuum adsorption platform 71 and movable relative to the first vacuum adsorption platform 71 in a vertical direction. The first positioning device 73 is used for aligning the flexible circuit board 34 with a first predetermined position of the first assembling table surface 711 in order to assist in placing the flexible circuit board 34 on the assembling table surface 711. When the flexible circuit board 34 or the combination of the flexible circuit board 34 and the reflective plate 33 is placed on the first predetermined position of the first assembling table surface 711, the flexible circuit board 34 or the combination of the flexible circuit board 34 and the reflective plate 33 is adsorbed by the first vacuum adsorption platform 71 according to vacuum adsorption.

Moreover, the second positioning device 74 is used for aligning the reflective plate 33 or the light-shading plate 31 with a second predetermined position of the second assembling table surface 721 in order to assist in placing the reflective plate 33 or the light-shading plate 31 on the second assembling table surface 721. When the reflective plate 33, the light-shading plate 31 or the combination of the light-shading plate 31 and the light guide plate 32 is placed on the second predetermined position of the second assembling table surface 721, the reflective plate 33, the light-shading plate 31 or the combination of the light-shading plate 31 and the light guide plate 32 is adsorbed by the second vacuum adsorption platform 72 according to vacuum adsorption. For facilitating the subsequent aligning procedures, the second predetermined position is determined according to the first predetermined position. The reason will be described later.

In this embodiment, the first positioning device 73 comprises plural positioning posts 731 on the first assembling table surface 711. Moreover, the positions of these positioning posts 731 are determined according to the first predetermined position of the first assembling table surface 711. Similarly, the second positioning device 74 comprises plural positioning posts 741 on the second assembling table surface 721. Moreover, the positions of these positioning posts 741 are determined according to the second predetermined position of the second assembling table surface 721. It is noted that the examples of the first positioning device 73 and the second positioning device 74 are not restricted. That is, the examples of the first positioning device 73 and the second positioning device 74 may be varied according to the practical requirements. For example, the first positioning device 73 or the second positioning device 74 is an automatic optical inspection (AOI) device for positioning any coupled element according to an automatic optical inspection (AOI) technology.

The backlight module assembling system 7 further comprises a rotating shaft 77. The rotating shaft 77 is connected with the second vacuum adsorption platform 72. Consequently, the second vacuum adsorption platform 72 is rotated with the rotating shaft 77.

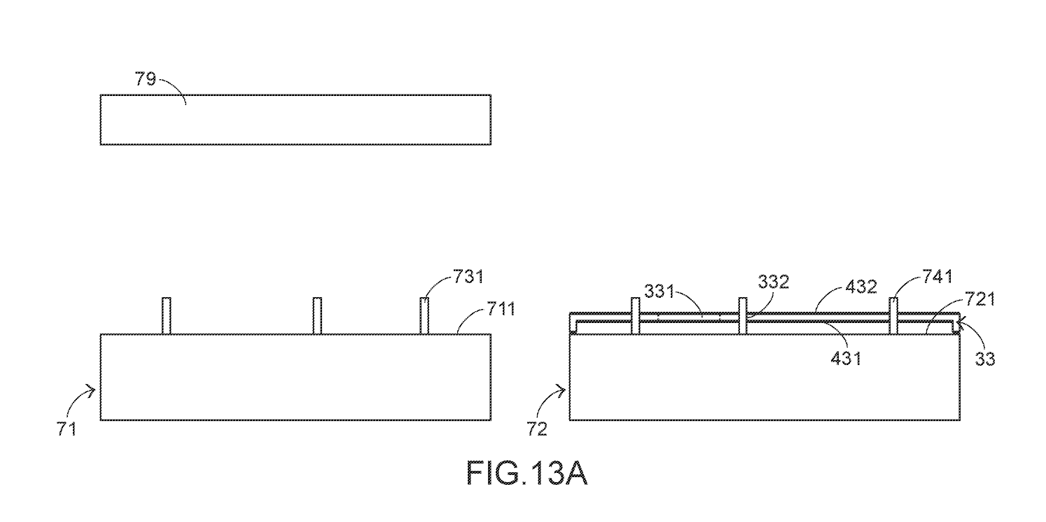

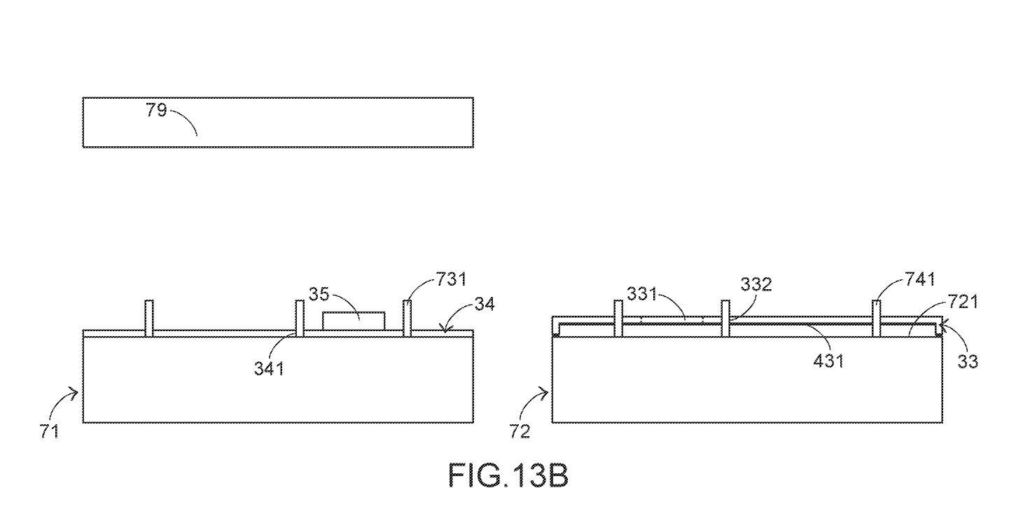

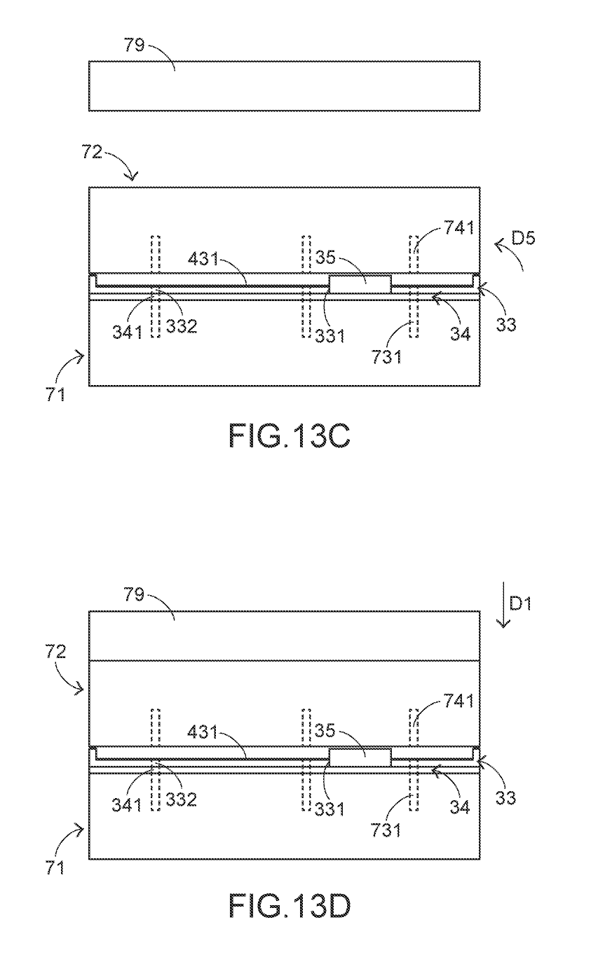

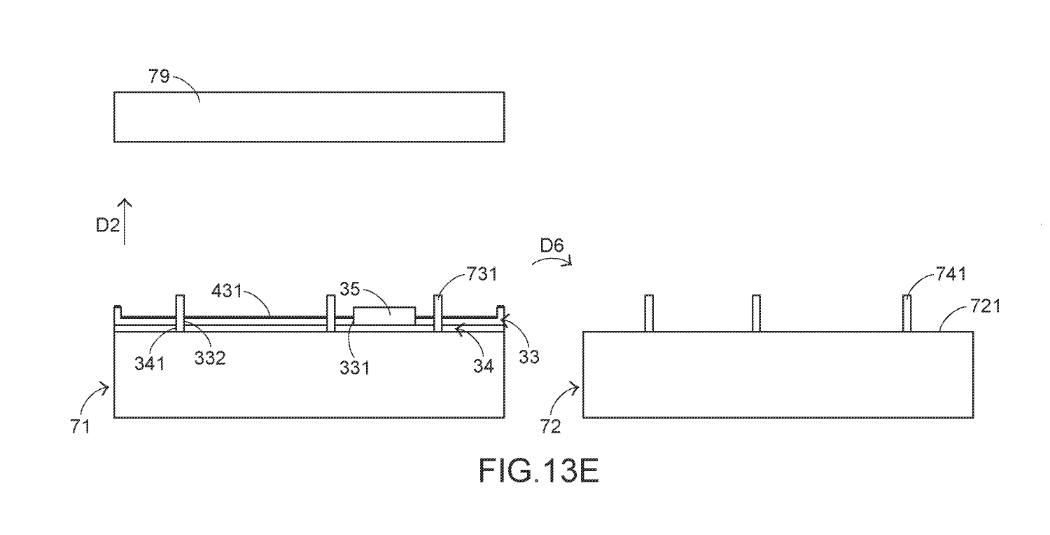

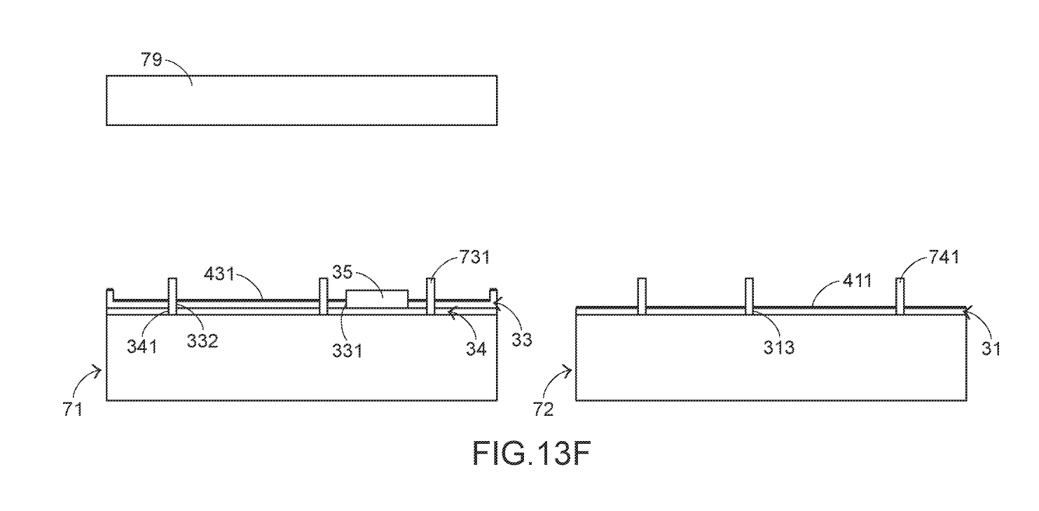

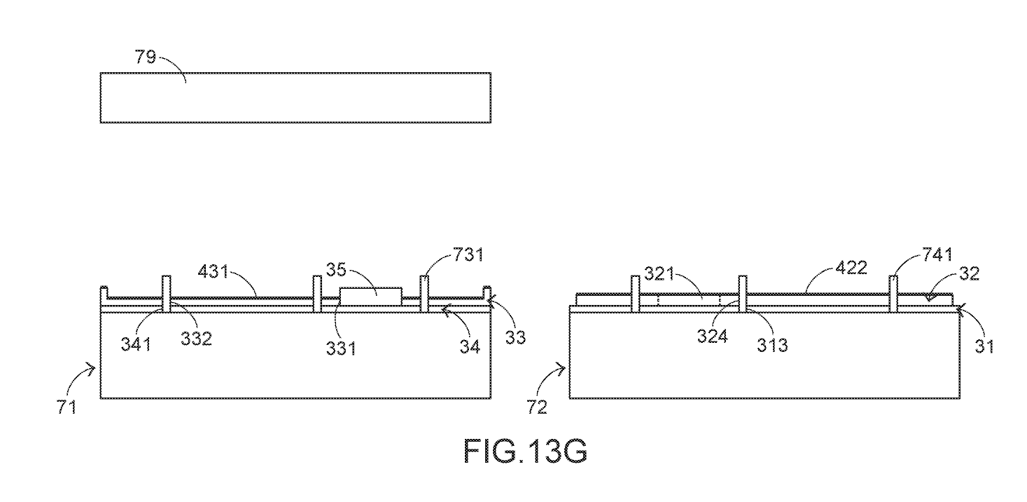

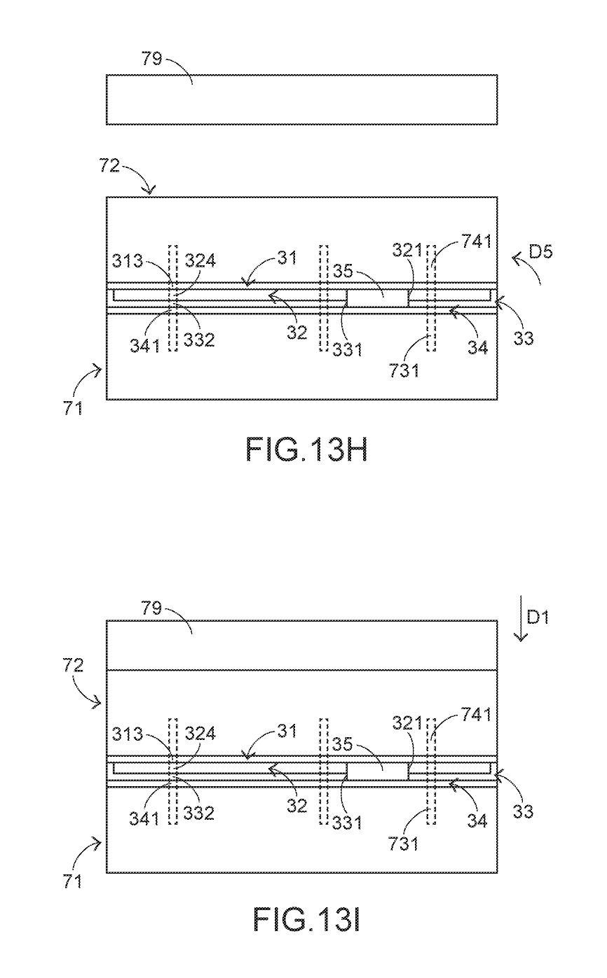

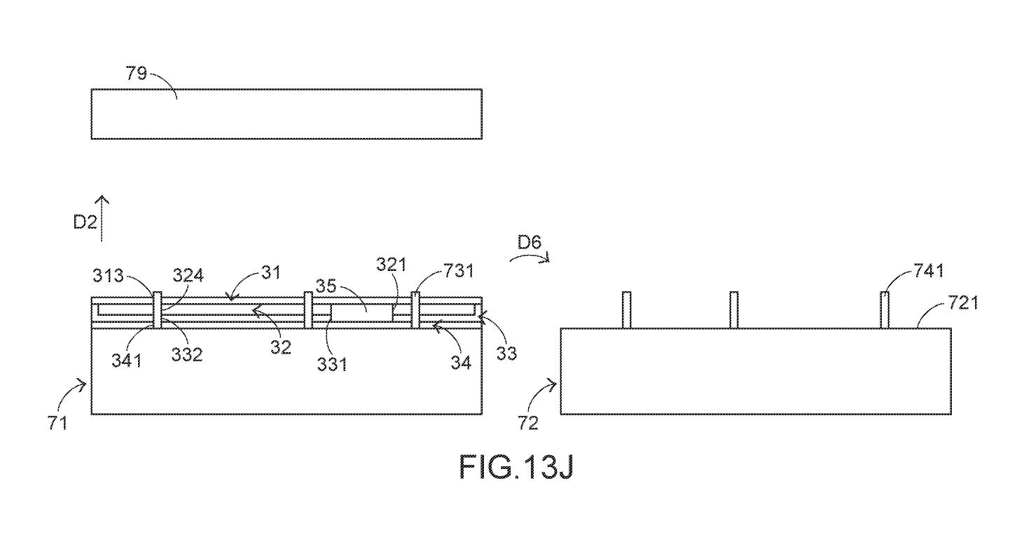

Hereinafter, the use of the backlight module assembling system 7 of FIG. 12 to assemble the backlight module 3 in the production line will be illustrated with reference to FIGS. 13A˜13J. FIGS. 13A˜13J schematically illustrate the steps of a backlight module assembling method performed by the backlight module assembling system of FIG. 12. For succinctness, only portions of the backlight module assembling system 7, the light-shading plate stock materials 41, the light guide plate stock materials 42, the reflective plate stock materials 43 and the flexible circuit board stock materials 44 are shown in FIGS. 13A˜13J. It is noted that the steps of the backlight module assembling method performed by the backlight module assembling system are not restricted to the steps of FIGS. 13A-13J. However, the steps of the backlight module assembling method may be varied according to the practical requirements.

Please refer to FIG. 13A. The top surface of the reflective plate 33 faces the second assembling table surface 721. Then, the reflective plate holes 332 of the reflective plate stock material 43 are aligned with the corresponding positioning posts 741 on the second assembling table surface 721. Then, the reflective plate holes 332 of the reflective plate stock material 43 are sheathed around the corresponding positioning posts 741. Consequently, the reflective plate stock material 43 is correspondingly placed on the second predetermined position of the second assembling table surface 721. After the reflective plate 33 is placed on the second assembling table surface 721, the reflective plate 33 is adsorbed by the second vacuum adsorption platform 72 according to vacuum adsorption. Consequently, the reflective plate 33 is evenly fixed on the second predetermined position of the second assembling table surface 721.

Please refer to FIG. 13B. After the reflective plate 33 is evenly fixed on the second predetermined position of the second assembling table surface 721, the lower protective film 432 of the reflective plate stock material 43 is removed by the assembling worker. Then, the flexible circuit board holes 341 of the flexible circuit board 34 are aligned with the corresponding positioning posts 731 on the first assembling table surface 711 by the assembling worker. Then, the flexible circuit board holes 341 of the flexible circuit board 34 are sheathed around the corresponding positioning posts 731. Consequently, the flexible circuit board 34 is correspondingly placed on the first predetermined position of the first assembling table surface 711. After the flexible circuit board 34 is placed on the first assembling table surface 711, the flexible circuit board 34 is adsorbed by the first vacuum adsorption platform 71 according to vacuum adsorption. Consequently, the flexible circuit board 34 is evenly fixed on the first predetermined position of the first assembling table surface 711. The step of FIG. 13A and the step of FIG. 13B may be exchanged according to the practical requirements.

Please refer to FIG. 13C. After the step of FIG. 13A and the step of FIG. 13B are performed, the rotating shaft 77 is driven to rotate. Consequently, the second vacuum adsorption platform 72 is rotated toward the first vacuum adsorption platform 71 in the direction D5. Meanwhile, the bottom surface of the reflective plate 33 is contacted with the flexible circuit board 34. Since plural lower colloidal glues 434 are disposed on the bottom surface of the reflective plate 33, the flexible circuit board 34 and the reflective plate 33 are glued together through the lower colloidal glues 434. Moreover, since the second predetermined position of the second assembling table surface 721 corresponds to the first predetermined position of the first assembling table surface 711, the reflective plate 33 and the flexible circuit board 34 are precisely aligned with each other. For example, all light emitting diodes 35 of the light source on the flexible circuit board 34 are precisely penetrated through the corresponding reflective plate openings 331 of the reflective plate 33.

Please refer to FIG. 13D. After the reflective plate 33 and the flexible circuit board 34 are combined together, the second vacuum adsorption platform 72 is not rotated away from the first vacuum adsorption platform 71 to the original position in the direction D6 in response to the rotation of the rotating shaft 77. Meanwhile, the pressing structure 79 over the first vacuum adsorption platform 71 is moved downwardly relative to the first vacuum adsorption platform 71 in a vertical direction (i.e., the direction D1). Consequently, the second vacuum adsorption platform 72 is contacted with and pressed by the pressing structure 79. Since the combination of the reflective plate 33 and the flexible circuit board 34 is pressed by the pressing structure 79, the reflective plate 33 and the flexible circuit board 34 are combined together more securely. In this embodiment, the positions of the backlight module 3 to be pressed by the pressing structure 79 are aligned with the corresponding lower colloidal glues 434.

Please refer to FIG. 13E. After the combination of the reflective plate 33 and the flexible circuit board 34 is pressed by the pressing structure 79, the pressing structure 79 is moved upwardly relative to the first vacuum adsorption platform 71 in the vertical direction (i.e., the direction D2). Then, the rotating shaft 77 is driven to rotate. Consequently, the second vacuum adsorption platform 72 is rotated away from the first vacuum adsorption platform 71 to the original position in the direction D6.

Please refer to FIG. 13F. After the second vacuum adsorption platform 72, the top surface of the light-shading plate 31 faces the second assembling table surface 721. Then, the light-shading plate holes 313 of the light-shading plate stock material 41 are aligned with the corresponding positioning posts 741 on the second assembling table surface 721. Then, the light-shading plate holes 313 of the light-shading plate stock material are sheathed around the corresponding positioning posts 741. Consequently, the light-shading plate stock material 41 is correspondingly placed on the second predetermined position of the second assembling table surface 721. After the light-shading plate 31 is placed on the second assembling table surface 721, the light-shading plate 31 is adsorbed by the second vacuum adsorption platform 72 according to vacuum adsorption. Consequently, the light-shading plate 31 is evenly fixed on the second predetermined position of the second assembling table surface 721.

Please refer to FIG. 13G. After the light-shading plate 31 is evenly fixed on the second predetermined position of the second assembling table surface 721, the protective film 411 of the light-shading plate stock material 41 by the assembling worker. Then, the upper protective film 421 of the light guide plate stock material 42 is removed, and the top surface of the light guide plate 32 faces the second assembling table surface 721. Then, the light guide plate holes 324 of the light guide plate stock material 42 are aligned with the corresponding positioning posts 741 on the second assembling table surface 721. Then, the light guide plate holes 324 of the light guide plate stock material 42 are sheathed around the corresponding positioning posts 741. Consequently, the light guide plate 32 is placed on the light-shading plate 31. Since plural colloidal glues 412 are disposed on the bottom surface of the light-shading plate 31, the light-shading plate 31 and the light guide plate 32 are glued together through the colloidal glues 412. Meanwhile, the combination of the light-shading plate 31 and the light guide plate 32 is adsorbed by the second vacuum adsorption platform 72 according to vacuum adsorption.

Please refer to FIG. 13H. After the light-shading plate 31 and the light guide plate 32 are combined together, the lower protective film 422 of the light guide plate stock material 42 and the upper protective film 431 of the reflective plate stock material 43 are removed by the assembling worker. Then, the rotating shaft 77 is driven to rotate. Consequently, the second vacuum adsorption platform 72 is rotated toward the first vacuum adsorption platform 71 in the direction D5. Meanwhile, the bottom surface of the light guide plate 32 and the non-periphery 338 at the top surface of the reflective plate 33 are contacted with each other, and the periphery region 319 at a bottom surface of the light-shading plate 31 and the peripheral region 339 at the top surface of the reflective plate 33 are contacted with each other. Moreover, the second predetermined position of the second assembling table surface 721 corresponds to the first predetermined position of the first assembling table surface 711. Consequently, the light-shading plate 31, the light guide plate 32, the reflective plate 33 and the flexible circuit board 34 are precisely aligned with each other. For example, all light emitting diodes 35 of the light source on the flexible circuit board 34 are precisely penetrated through the corresponding light guide plate openings 321 of the light guide plate 32.

Please refer to FIG. 13I. After the flexible circuit board 34, the reflective plate 33, the light guide plate 32 and the light-shading plate 31 are combined together, the second vacuum adsorption platform 72 is not rotated away from the first vacuum adsorption platform 71 to the original position in the direction D6 in response to the rotation of the rotating shaft 77. Meanwhile, the pressing structure 79 over the first vacuum adsorption platform 71 is moved downwardly relative to the first vacuum adsorption platform 71 in the vertical direction (i.e., the direction D1). Consequently, the second vacuum adsorption platform 72 is contacted with and pressed by the pressing structure 79. Since the combination of the flexible circuit board 34, the reflective plate 33, the light guide plate 32 and the light-shading plate 31 is pressed by the pressing structure 79, the flexible circuit board 34, the reflective plate 33, the light guide plate 32 and the light-shading plate 31 are combined together more securely.

In an embodiment, the positions of the backlight module 3 to be pressed by the pressing structure 79 are aligned with the corresponding colloidal glues 412, 433 and 434. For example, the peripheral region 339 at the top surface of the reflective plate 33 is an important position for installing the colloidal glues 433. That is, the pressing structure 79 is moved downwardly to press the peripheral region 339 at the top surface of the reflective plate 33. Consequently, the light guide plate 32 is covered between the light-shading plate 31 and the reflective plate 33. In this way, the light beams are not leaked out from the lateral sides of the light guide plate 32, and the backlight module 3 is waterproof.

Please refer to FIG. 13J. After the flexible circuit board 34, the reflective plate 33, the light guide plate 32 and the light-shading plate 31 are combined together, the pressing structure 79 is moved upwardly relative to the first vacuum adsorption platform 71 in the vertical direction (i.e., the direction D2). Then, the rotating shaft 77 is driven to rotate. Consequently, the second vacuum adsorption platform 72 is rotated away from the first vacuum adsorption platform 71 to the original position in the direction D6. Then, the combination of the flexible circuit board 34, the reflective plate 33, the light guide plate 32 and the light-shading plate 31 is removed from the first vacuum adsorption platform 71 by the assembling worker. Consequently, the assembling process of the backlight module 3 is completed. Preferably but not exclusively, the first vacuum adsorption platform 71 further comprises a push structure (not shown). After the backlight module 3 is assembled, the push structure pushes the backlight module 3 from bottom to top. Consequently, the backlight module 3 can be removed from the first vacuum adsorption platform 71 more easily.

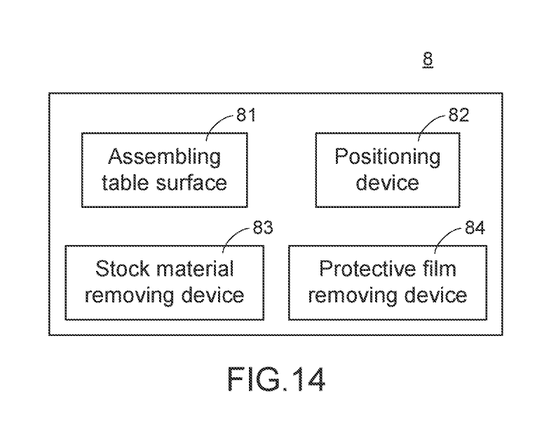

FIG. 14 is a schematic functional block diagram illustrating a portion of a backlight module assembling system according to a fourth embodiment of the present invention. Since the components of the backlight module assembling system 8 of this embodiment are substantially identical to those of the first, second and third embodiments, only the distinguished aspects will be described as follows. In comparison with the above embodiments, the backlight module assembling system 8 is an automatic assembling system. The backlight module assembling system 8 further comprises a stock material removing device 83 and a protective film removing device 84. The stock material removing device 83 is used for picking up the required stock materials (e.g., the light-shading plate stock material 41, the light guide plate stock material 42, the reflective plate stock material 43 or the flexible circuit board stock material 44) from a stock material store place (not shown). Moreover, the picked stock material is aligned with and placed on a predetermined position of an assembling table surface 81 by the stock material removing device 83 according to a positioning device 82. The protective film removing device 84 is used for removing the protective film of the stock material. The timing of removing the protective film is dependent on the actual assembling procedure. For example, in an embodiment, the protective film is removed after the stock material is picked up from the stock material store place and before the stock material is placed on the assembling table surface 81.

It is noted that numerous modifications and alterations may be made while retaining the teachings of the invention. For example, in another embodiment, the arranging sequence of the components of the backlight module from top to bottom is changed. For example, the flexible circuit board is disposed over the light-shading plate, and the light emitting diodes of the light source on the flexible circuit board are penetrated through the corresponding light-shading plate openings and the corresponding light guide plate openings from top to bottom. By retaining the teachings of the above embodiments, the assembling work in the production line can assemble the backlight light through the modified assembling method.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A backlight module assembling method for assembling a backlight module of a luminous keyboard, the backlight module comprising a first coupled element and a second coupled element in a stack form, at least one of the first coupled element and the second coupled element is equipped with plural coupling objects, the first coupled element and the second coupled element being combined together through the plural coupling objects, the backlight module assembling method comprising steps of:
(a) providing a positioning device, wherein after the first coupled element is aligned with a predetermined position of an assembling table surface through the positioning device, the first coupled element is placed on the predetermined position of the assembling table surface; and
(b) allowing the first coupled element on the predetermined position of the assembling table surface to be adsorbed according to vacuum adsorption, so that the first coupled element is evenly fixed on the predetermined position of the assembling table surface, wherein after the first coupled element is evenly fixed on the predetermined position of the assembling table surface, the second coupled element is aligned with and placed on the first coupled element, so that the second coupled element and the first coupled element are combined together.

2. The backlight module assembling method according to claim 1, wherein the second coupled element is aligned with and placed on the first coupled element through the positioning device.

3. The backlight module assembling method according to claim 1, wherein the positioning device is an automatic optical inspection (AOI) device, or the positioning device comprises at least one positioning post on the assembling table surface, wherein at least one first positioned hole of the first coupled element is sheathed around the corresponding positioning post, or at least one second positioned hole of the second coupled element is sheathed around the corresponding positioning post.

4. The backlight module assembling method according to claim 1, wherein after the second coupled element is aligned with and placed on the first coupled element, the backlight module assembling method further comprises a step (c) of pressing at least one pressed position of a combination of the first coupled element and the second coupled element.

5. The backlight module assembling method according to claim 4, wherein the at least one pressed position is aligned with at least one of the plural coupling objects.

6. The backlight module assembling method according to claim 1, wherein from top to bottom, the backlight module comprises a light-shading plate, a light guide plate, a reflective plate and a flexible circuit board with a light source, wherein the first coupled element is the flexible circuit board, and the second coupled element is the reflective plate.

7. The backlight module assembling method according to claim 6, wherein the reflective plate has a reflective plate opening corresponding to the light source, wherein when the second coupled element is aligned with and placed on the first coupled element, the light source is penetrated through the reflective plate opening.

8. The backlight module assembling method according to claim 1, wherein from top to bottom, the backlight module comprises a light-shading plate, a light guide plate, a reflective plate and a flexible circuit board with a light source, wherein the first coupled element is the light-shading plate, and the second coupled element is the light guide plate.

9. The backlight module assembling method according to claim 1, wherein from top to bottom, the backlight module comprises a light-shading plate, a light guide plate, a reflective plate and a flexible circuit board with a light source, wherein the first coupled element is a combination of the flexible circuit board and the reflective plate, and the second coupled element is a combination of the light-shading plate and light guide plate.

10. The backlight module assembling method according to claim 9, wherein the light guide plate has a light guide plate opening corresponding to the light source, wherein when the second coupled element is aligned with and placed on the first coupled element, the light source is penetrated through the light guide plate opening.

11. The backlight module assembling method according to claim 1, wherein at least one of the plural coupling objects is a colloidal glue.
